(19) United States
(12) Patent Application Publication
(10) Pub. No.: US 2017/0288933 A1
(43) Pub. Date: Oct. 5, 2017

(54) WIRELESS SIGNAL RECEIVER

(71) Applicant: Intel IP Corporation, Santa Clara, CA (US)

(72) Inventors: Ahmed Gamal Helmy Mohamed, Santa Clara, CA (US); Thomas J. Kenney, Portland, OR (US); Shahrnaz Azizi, Cupertino, CA (US)

(21) Appl. No.: 15/085,299

(22) Filed: Mar. 30, 2016

(51) Int. Cl. H04L 27/26; H04B 7/08

(52) U.S. Cl. CPC H04L 27/2697; H04L 27/2653; H04B 7/0891

(57) ABSTRACT

A satisfactory list detection (LD) receiver based on spatial modulation (SM) orthogonal frequency division multiplexing (OFDM) waveform is provided. In some embodiments, the LD receiver can implement a suboptimal LD detection process that relies on a reduced search space an optimal joint ML detection-based process for the SM-OFDM transmission mode. In some aspects, the overall search space for the optimal joint ML is determined by the total spectral efficiency, which can be divided into two information categories with two different search spaces defined by the number of bits of each category. As such, in some aspects, the LD receiver can permit detecting, with reduced complexity, antenna bits and data bits based on a determination of respective log-likelihood ratios.

### BACKGROUND

Certain protocols for wireless communications, such as IEEE 802.11ax, can be directed to dense deployments where various types of devices can communicate wirelessly within network. The devices can include laptop computers, Internet of Things (IoT) devices and wearables devices. Thus, enhancing the physical layer (PHY) of such devices without increasing device complexity and/or cost can improve spectral efficiency in dense deployments.

### BRIEF DESCRIPTION OF THE DRAWINGS

The accompanying drawings form an integral part of the disclosure and are incorporated into the present specification. The drawings illustrate example embodiments of the disclosure and, in conjunction with the description and claims, serve to explain at least in part various principles, features, or aspects of the disclosure. Certain embodiments of the disclosure are described more fully below with reference to the accompanying drawings. However, various aspects of the disclosure can be implemented in many different forms and should not be construed as limited to the implementations set forth herein. Like numbers refer to like elements throughout.

FIG. 1 presents an example of an operational environment for wireless communication in accordance with one or more embodiments of the disclosure.

FIG. 2 presents an example of a network environment in accordance with one or more embodiments of the disclosure.

FIG. 3 presents an example of a device in accordance with one or more embodiments of the disclosure.

FIG. 4 presents an example of a radio unit for wireless communication in accordance with one or more embodiments of the disclosure.

FIG. 5 illustrates detection performance of direct mapping with optimal detection, spatial modulation (SM) with sub-optimal list detection (SM-LD) and optimal maximum likelihood detection (SM) in accordance with one or more embodiments of the disclosure.

FIG. 6 presents an example of a computational environment for wireless communication in accordance with one or more embodiments of the disclosure.

FIG. 7 presents another example of a device for wireless communication in accordance with one or more embodiments of the disclosure.

FIGS. 8-9 present examples of method for wireless communication in accordance with one or more embodiments of the disclosure.

### DETAILED DESCRIPTION

The disclosure recognizes and addresses, in at least some embodiments, the issue of detection of wireless signal in a densely deployed wireless network. More particularly, yet not exclusively, the disclosure can provide a satisfactory list detection (LD) process based on spatial modulation (SM) orthogonal frequency division multiplexing (OFDM) waveform. Some aspects of SM-OFDM include mapping an incoming block of information bits (e.g., coded bits) to be transmitted from an access point (AP) device (or any other transmitter device) at each subcarrier to two information categories: (1) data bitstream and (ii) antenna selection bitstream. Specifically, the incoming block of information bits to be transmitted from the AP device can be mapped to two information carrying units m and n that represent, respectively, symbol and antenna selections, as follows: (1) Signal constellation—A symbol selected from a constellation diagram, where m=log₂ M, with M representing a signal constellation alphabet size. (2) Space Constellation—A unique active transmit antenna index or a combination of other unique active transmit antenna indices selected from a set of possible transmit antennas combinations to be used (exclusively or otherwise) during transmission. Here,

$$n = {⌊ {log}_{2} ( ( \begin{matrix}{N}_{T} \\ {N}_{act}\end{matrix} ) ) ⌋}_{2} ,$$

with └.┘₂ representing the flooring operation to the nearest integer that can be expressed as power of 2; N_{T} representing a number of transmit antennas; and N_{act}≦N_{T} representing a number of active transmit antennas. As such, in some aspects, an LD detector device in accordance with the disclosure can be used for SM-OFDM transmitted waveforms. A wireless network that is densely deployed, such as dense Wi-Fi deployments, can have a mix of high-end devices (such as laptops) currently available along with very low power, small form factor devices (such as IoT devices, wearable devices, or the like), which, in some instances, can be less complex than larger form factor devices. Therefore, in some aspects of the disclosure, an AP device may have to communicate efficiently with such less complex devices while improving the overall system spectral efficiency. Embodiments of the disclosure can permit or otherwise facilitate designs of MIMO-OFDM waveforms that can improve detection and overall performance of client devices (e.g., station devices, customer premises equipment (CPE), sensors, or the like) that may have limited number of active RF chains. Further or in other embodiments, the disclosed LD detection process can provide performance gains over detection based on direct mapping with maximum likelihood (ML) optimal detection, such as it may be the case in a conventional transmitter design without a SM-OFDM transmitter design (which may be contemplated in IEEE long-range low-power (LRLP) Wi-Fi, IEEE 802.11 a/g/n/ac, or the like).

As described in greater detail below, the disclosure provides, among other things, devices, systems, techniques, and/or computer program products for a suboptimal detection procedure based on a list detection (LD) algorithm for a SM-OFDM waveform. The disclosed detection procedure may be implemented in radio technology protocols, such as extensions of IEEE 802.11ah (e.g., LRLP Wi-Fi), IEEE 802.11ax, and/or other more sophisticated family of protocols. In some aspects, the suboptimal detection procedure described herein can be less complex that conventional detection algorithms, while having negligible performance degradation with respect to such algorithms. Thus, such a type of receiver can be utilized or otherwise leveraged in detection of wireless signals including SM-OFDM transmissions which can be suitable for small-form-factor, low cost devices, such as IoT devices. In addition or in other aspects, the suboptimal LD detection procedure combined with an SM-OFDM transmitter can provide performance gains over an optimal joint Maximum-Likelihood (ML) detection procedure with a conventional transmitter design, such as the transmitter typically utilized in IEEE 802.11a/g/n/ac standard.

As described in greater detail below, embodiments of the disclosure provide a suboptimal, less complex, and high performance detection procedure based on the List Detection (LD) for SM-OFDM. One of the principles of the suboptimal LD detection algorithm is to reduce the search space of the optimal joint ML detection-based algorithm for the SM-OFDM transmission mode. Basically, the overall search space for the optimal joint ML is determined by the total spectral efficiency. Based on the main concept of SM-OFDM, the spectral efficiency is divided into two information categories with two different search spaces defined by the number of bits of each category (no. of antenna selection bits+no. of data bits=total spectral efficiency). Hence, reducing the search space of the antenna selection bits category while improving the performance will have a big advantage in addressing the overall detection algorithm complexity/performance tradeoff especially for IoTs and wearables. Therefore, in at least some embodiments, the disclosure provides a low complexity (low cost) suboptimal LD detector that still achieves better performance, when using SM-OFDM then the current 0.11ac transmitter with the optimal ML receiver.

At least some embodiments of the disclosure can provide advantages over conventional receivers and related detection processes. In general, at least in IEEE 802.11ax dense network deployments, the disclosed LD detector and associated detection procedure can permit reducing the receiver design complexity, which can be a desirable element in the design (e.g., cost and/or size) of small form factor devices (e.g., IoT devices and wearable devices). As an illustration, at least some embodiments of the disclosure can permit or otherwise facilitate reducing the complexity of detection procedure of wireless signals while improving the PHY-rate, which can be leveraged to comply with at least some of the requirements in advanced radio technology protocols, such as IEEE 802.11ax standards and more sophisticated radio technology protocols. More specifically, in some aspects, the disclosed LD detector in combination with the SM-OFDM waveform can provide at least the following example advantages over conventional systems, such as IEEE 802.11 systems. In one example, SM-OFDM can apply a suboptimal detection process at an IoT or wearable device's receiver using the sub-optimal list detector (LD). As such, SM can achieve, with the disclosed sub-optimal LD, significant gains over direct mapping with optimal detection, as is employed in some conventional systems. In another example, SM-OFDM can achieve gains (some of them being significant) with the disclosed complexity reduction reception techniques. In one aspect, IoT devices and wearable devices (which collective may be referred to as client devices) can presents more pronounced gains. In yet another example, SM-OFDM, with the disclosed sub-optimal LD can increase overall system spectral efficiency at the same number of RF chains available at an AP device as that in conventional multiple-input multiple-output (MIMO) communication.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless AP device, a wireline or wireless router device, a wireline or wireless modem device, a video device, an audio device, an audio-video (A/V) device, a network node or a wiredline or wireless network, a wireless area network, a wireless video area network (WVAN), a local area network (LAN), a WLAN, a personal area network (PAN), a wireless PAN (WPAN), and the like.

In addition or in the alternative, some embodiments of this disclosure may be implemented in conjunction with one-way and/or two-way radio communication systems, cellular radio-telephone communication systems, a mobile phone, a cellular telephone, a wireless telephone, a personal communication systems (PCS) device, a PDA device which incorporates a wireless communication device, a mobile or portable global positioning system (GPS) device, a device which incorporates a GPS receiver or transceiver or chip, a device which incorporates a radio frequency identification (RFID) element or chip, a MIMO transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MCM), discrete multi-tone (DMT), Bluetooth®, global positioning system (GPS), Wi-Fi, Wi-Max, ZigBee™, ultra-wideband (UWB), global system for mobile communication (GSM), 2G, 2.5G, 3G, 3.5G, 4G, fifth generation (5G) mobile networks, 3GPP, long term evolution (LTE), LTE advanced, enhanced data rates for GSM evolution (EDGE), or the like. Other embodiments may be used in various other devices, systems, and/or networks.

While various embodiments of the disclosure are illustrated in connection with devices or network of devices that can operate according to IEEE 802.11 protocols (such as LRLP Wi-Fi protocols, IEEE 802.11ax protocols, and the like), it is noted that this disclosure is not limited in this respect and embodiments of the disclosure can be implemented in devices or network of devices that operate according to other protocols for wireless communication.

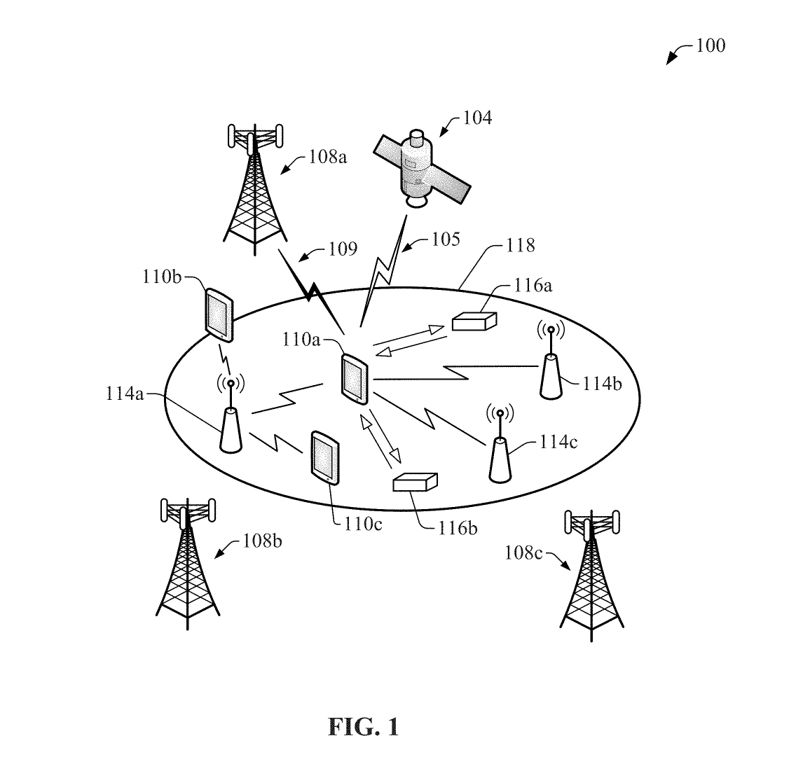

With reference to the drawings, FIG. 1 presents a block diagram of an example operational environment 100 for wireless communication in accordance with at least certain aspects of the disclosure. The operational environment 100 includes several telecommunication infrastructures and communication devices, which collectively can embody or otherwise constitute a telecommunication environment. More specifically, yet not exclusively, the telecommunication infrastructures can include a satellite system 104. As described herein, the satellite system 104 can be embodied in or can include a global navigation satellite system (GNSS), such as the Global Positioning System (GPS), Galileo, GLONASS (Globalnaya navigatsionnaya sputnikovaya sistema), BeiDou Navigation Satellite System (BDS), and/or the Quasi-Zenith Satellite System (QZSS). In addition, the telecommunication infrastructures can include a macro-cellular or large-cell system; which is represented with three base stations 108a-108c; a micro-cellular or small-cell system, which is represented with three access points (or low-power base stations) 114a-114c; and a sensor-based system—which can include proximity sensor(s), beacon device(s), pseudo-stationary device(s), and/or wearable device(s)—represented with functional elements 116a-116c. As illustrated, in one implementation, each of the transmitter(s), receiver(s), and/or transceiver(s) included in respective computing devices (such as telecommunication infrastructure) can be functionally coupled (e.g., communicatively or otherwise operationally coupled) with the wireless device 110a (also referred to as communication device 110a) via wireless link(s) in accordance with specific radio technology protocols (e.g., IEEE 802.11a, IEEE 802.11ah, IEEE 802.11ax, etc.) in accordance with aspects of this disclosure. For another example, a base station (e.g., base station 108a) can be functionally coupled to the wireless devices 110a, 110b, and 110c via respective an upstream wireless link (UL) and a downstream link (DL) configured in accordance with a radio technology protocol for macro-cellular wireless communication (e.g., 3^{rd} Generation Partnership Project (3GPP) Universal Mobile Telecommunication System (UMTS) or “3G,” “3G”; 3GPP Long Term Evolution (LTE), or LTE); LTE Advanced (LTE-A)). For yet another example, an access point (e.g., access point (AP) device 114a) can be functionally coupled to one or more of the wireless devices 110a, 110b, or 110c via a respective UL and DL configured in accordance with a radio technology protocol for small-cell wireless communication (e.g., femtocell protocols, Wi-Fi, and the like). For still another example, a beacon device (e.g., device 116a) can be functionally coupled to the wireless device 110a with a UL-only (ULO), a DL-only, or an UL and DL, each of such wireless links (represented with open-head arrows) can be configured in accordance with a radio technology protocol for point-to-point or short-range wireless communication (e.g., ZigBee™, Bluetooth, or near field communication (NFC) standards, ultrasonic communication protocols, or the like).

In the operational environment 100, the small-cell system and/or the beacon devices can be contained in a confined area 118 that can include an indoor region (e.g., a commercial facility, such as a shopping mall) and/or a spatially-confined outdoor region (such as an open or semi-open parking lot or garage). The small-cell system and/or the beacon devices can provide wireless service to a device (e.g., wireless device 110a or 110b) within the confined area 118. For instance, the wireless device 110a can handover from macro-cellular wireless service to wireless service provided by the small-cell system present within the confined area 118. Similarly, in certain scenarios, the macro-cellular system can provide wireless service to a device (e.g., the wireless device 110a) within the confined area 118.

In certain embodiments, the wireless device 110a, as well as other communication devices (wireless or wireline) contemplated in the present disclosure, can include electronic devices having computational resources, including processing resources (e.g., processor(s)), memory resources (memory devices (also referred to as memory), and communication resources for exchange of information within the computing device and/or with other computing devices. Such resources can have different levels of architectural complexity depending on specific device functionality. Exchange of information among computing devices in accordance with aspects of the disclosure can be performed wirelessly as described herein, and thus, in one aspect, the wireless device 110a also can be referred to as wireless communication device 110a, wireless computing device 110a, communication device 110a, or computing device 110a interchangeably. The same nomenclature considerations apply to wireless device 110b and wireless device 110c. More generally, in the present disclosure, a communication device can be referred to as a computing device and, in certain instances, the terminology “communication device” can be used interchangeably with the terminology “computing device,” unless context clearly dictates that a distinction should be made. In addition, a communication device (e.g., communication device 110a or 110b or 110c) that operates according to HEW can utilize or leverage a physical layer convergence protocol (PLCP) and related PLCP protocol data units (PPDUs) in order to transmit and/or receive wireless communications. Example of the computing devices that can communicate wirelessly in accordance with aspects of the present disclosure can include desktop computers with wireless communication resources; mobile computers, such as tablet computers, smartphones, notebook computers, laptop computers with wireless communication resources, Ultrabook™ computers; gaming consoles, mobile telephones; blade computers; programmable logic controllers; near field communication devices; customer premises equipment with wireless communication resources, such as set-top boxes, wireless routers, wireless-enabled television sets, or the like; and so forth. The wireless communication resources can include radio units (also referred to as radios) having circuitry for processing of wireless signals, processor(s), memory device(s), and the like, where the radio, the processor(s), and the memory device(s) can be coupled via a bus architecture.

The computing devices included in the example operational environment 100, as well as other computing devices contemplated in the present disclosure, can implement detection of wireless signal according to a wireless signal receiver as described herein. It should be appreciated that other functional elements (e.g., servers, routers, gateways, and the like) can be included in the operational environment 100. It should be appreciated that the wireless signal detection aspects of this disclosure can be implemented in any telecommunication environment including a wireline network (e.g., a cable network, an internet-protocol (IP) network, an industrial control network, any wide area network (WAN), a local area network (LAN), a personal area network (PAN), a home area network (HAN) (such as a sensor-based network) or the like); a wireless network (e.g., a cellular network (either small-cell network or macro-cell network), a wireless WAN (WWAN), a wireless LAN (WLAN), a wireless PAN (WPAN), a wireless HAN, such as a wireless sensor-based network, a satellite network, or the like); a combination thereof; or the like.

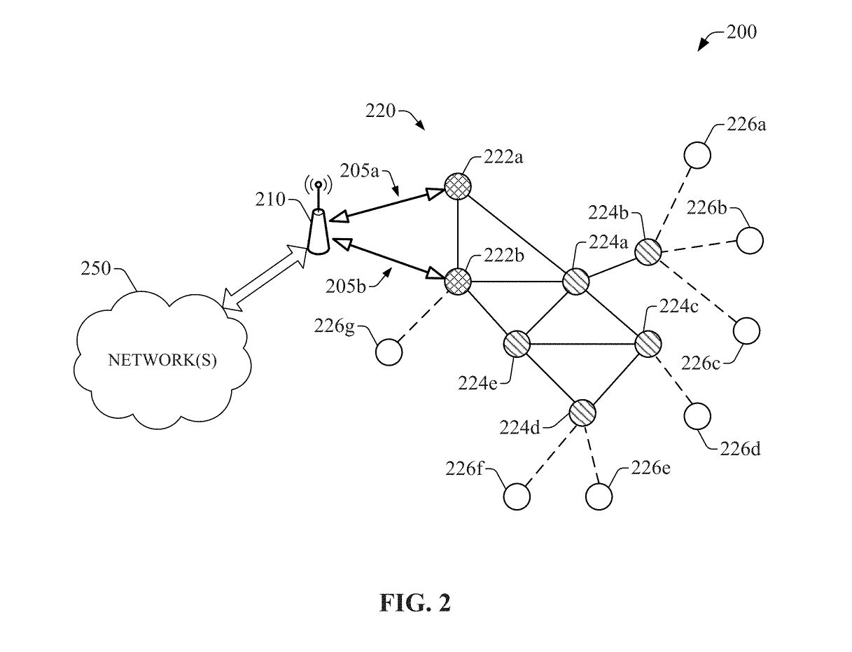

FIG. 2 illustrates an example of an operational environment 200 in accordance with one or more embodiments of the disclosure. The operational environment 200 includes a mesh network 220 having devices that can operate according to Thread protocols and/or any other communication protocols suitable for, among other things, IP-based communication (e.g., IPv6 protocol), low-power, secure, low-latency (e.g., less than about 100 ms) and/or scalable operation of the devices (e.g., smartphones, tablet computers, appliances, sensors, locks, and the like). The devices can include, in some embodiments; appliances; devices for access controls (e.g., locks); devices for climate control (e.g., temperature sensors, heaters, refrigeration devices, etc.); devices for energy management, lamps, light bulbs, or other type of devices for lightning; devices for safety (e.g., cameras) and or other types of security (e.g., alarms). Some of the devices can be powered via a conventional power grid, other devices can be powered via a combination between power grid and battery or other type of energy storage, and yet other devices can be powered via batteries or elements for energy harvesting. At least some of the devices included in the mesh network 220 also can communicate according to other protocols, such as Wi-Fi protocols, beyond Thread protocols or NAN protocols. In some implementations, the mesh network 220 is functionally coupled to an AP device 210 that permits functional coupling with one or more external networks 250 (such as the Internet or another type of WAN/WWAN). One or more devices within the mesh network 220 can permit functional coupling between the mesh network 220 and the AP device 210, each of the one or more devices can be referred to as border router device (or border router). In some embodiments, Wi-Fi wireless links can permit exchange of information between the AP device 220 and the one or more border routers. In other embodiments, other types of wireless links (e.g., femtocell wireless links) or wireline links (e.g., Ethernet links) can permit communication between the one or more border router devices and the AP device 210. As illustrated, in the operational environment 200, border routers 222a and 222b can be functionally coupled to AP device 201 via Wi-Fi links 205a and 205b, respectively. A border router can be functionally coupled to one or more devices within the mesh network 220, at least one of the devices coupled to the border router can be referred to as a router node (or router device or router). Other device(s) coupled to the border router can be a leaf node (e.g., a SED). Border routers provide services, such as routing services for off-network operations, for devices within the mesh network 220.

A router can provide routing services to devices within the mesh network 220. In addition or in the alternative, a router can provide joining services and/or security services for a device that attempts to join the mesh network 220. As opposed to SEDs, a router is not configured to enter a power-off mode or other type of low-power state. The exemplified operational environment includes five routers 224a-224d. In some embodiments, border routers and routers can exchange information according to Thread protocols. In one example, wireless links pertaining to a Thread WPAN (such as 6Lo links) can permit communication of network data and/or network signaling between such devices. Such links are represented as solid lines in FIG. 2.

In addition, a router (e.g., router 224b) can be coupled to one or more leaf nodes (or leaf devices) within the mesh network 220. In one implementation, a lead node can be referred to as a SED. A leaf node (or SED) can be embodied in or can include a host device, and can communicate via a parent router associated with the lead node. As such, the leaf node cannot forward messages to another lead node. The illustrated operational environment 200 includes seven leaf nodes 226a-226g. In some embodiments, wireless links pertaining to a Thread WPAN (such as 6Lo Sleepy links) can permit communication of network data and/or network signaling between a router and a leaf node. Such wireless links are represented with dashed lines in FIG. 2. A leaf node (or SED) can be powered via a battery or other type of energy storage and supply device. In addition or in some embodiments, a leaf node can be powered via a device that permits harvesting energy (e.g., a solar panel, a turbine, geothermal energy conversion devices, etc.). Leaf nodes can include one or more of thermostat, light switches, smoke detectors, carbon monoxide detectors, displays, door bells, intrusion sensors, automated cleaning devices, door sensors or other type of presence sensors, actuation sensors (e.g., window, door, etc.), motion sensors, door locks, radiator valves, biometric devices, fans, smart plugs, smart meters, appliances, HVAC equipment, a combination thereof, or the like.

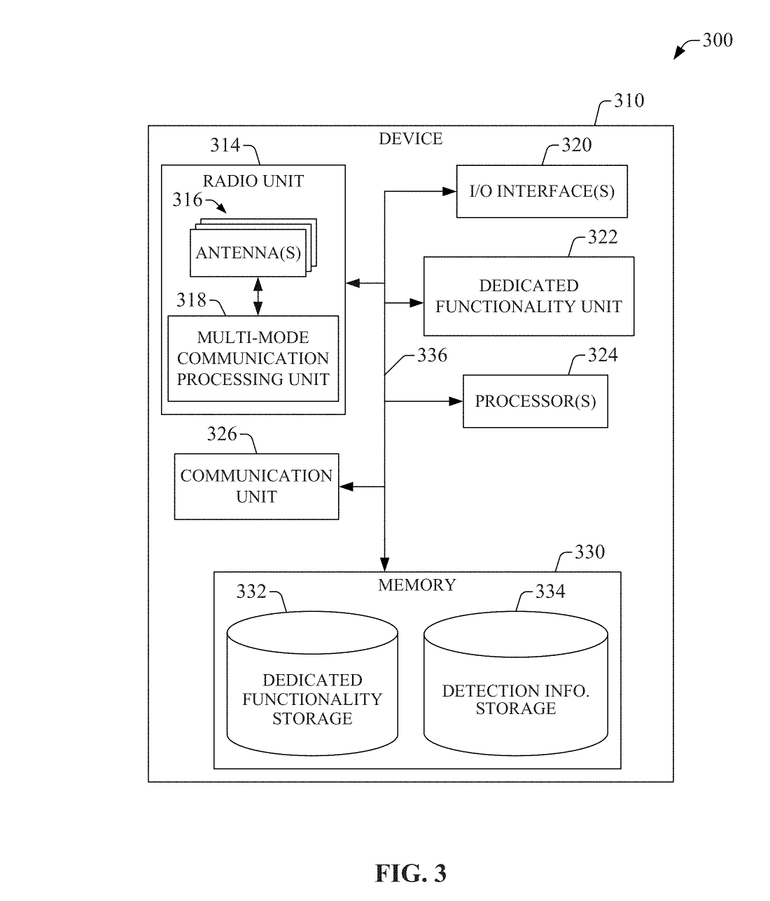

FIG. 3 illustrates a block diagram of an example embodiment of a device 310 in accordance with one or more embodiments of the disclosure. The exemplified device 310 can operate in accordance with at least some aspects of the disclosure, implementing power-saving operations as described herein, for example. As mentioned, in some embodiments, the device 310 can embody or can constitute any one of devices in the operational environment 100. Similarly, in other embodiments, the device 310 can embody or can constitute a device in a low-power mesh network, such as the example mesh network 220 in FIG. 2. As such, the device 310 can embody a border router device, a router device, a leader device, or a SED. In yet other embodiments, the device 310 can embody or can constitute an AP device of the AP device(s) 114a, 114b, or 114c or an IoT devices of the IoT device(s) 226a-226g in the operational environment 200. As such, in some aspects, the device 310 can provide one or more specific functionalities—such as operating as a digital camera and generating digital images (e.g., static pictures and/or motion pictures); operating as a navigation device; operating as a biometric device (e.g., a heart rate monitor, a pressure monitor, a glucometer, an iris analyzer, a fingerprint analyzer, etc.); dosing and delivering an amount of a drug or other compound; operating as a sensor and sensing a defined physical quantity, such as temperature and/or pressure, or motion; operating as another sensor and sensing a compound in gas phase or liquid phase; operating as a controller for configuring a second defined physical quantity, managing energy, managing access to an environment, managing illumination and/or sound, regulating a defined process, such an automation control process, or the like; generating current, voltage, or other type of signal via inductive coils; a combination of the foregoing; a derivative functionality of the foregoing; or the like. To that end, the device 310 can include one or more functionality units 322 (referred to as dedicated functionality unit 322) that can include optical elements (e.g., lenses, collimators, light guides, light sources, light detectors (such as semiconductor light detectors), focusing circuitry, etc.); temperature sensors; pressure sensors; gas sensors; motion sensors, including inertial sensors (such as linear accelerator and/or a gyroscope); mechanical actuators (such as locks, valves, and the like); a combination of the foregoing; or the like.

In addition or in other aspects, a specific functionality of the device 310 can be provided or otherwise implemented via one or more processors 324. In some implementations, at least one of the processor(s) 324 can be integrated with dedicated functionality unit 322. In some implementations, at least one of the processor(s) (e.g., one or more of the processor(s) 324 or other processor(s)) can receive and operate on data and/or other type of information (e.g., analog signals) generated by components of the dedicated functionality unit 322. The at least one processor can execute a module in order to operate on the data and/or other type of information and, as a result, provide a defined functionality. The module can be embodied in or can include, for example, a software application stored in a memory device integrated into or functionally coupled to the device. For instance, the module can be retained in one or more memory devices 532 (collectively referred to as dedicated functionality storage 532), where the dedicated functionality storage 532 can be retained within one or more other memory devices 530 (collectively referred to as device 530). In addition or in other implementations, at least a second one of the processor(s) (e.g., one or more of processor(s) 324 or other processor(s) available to the dedicated functionality unit 322) can control the operation or duty cycle of a portion of the dedicated functionality unit 322 so as to collect data and/or other type of information; provide an amount (or a dose) of a compound or acquire another amount of another compound or material; a combination of the foregoing; or the like. At least one of the units that constitute the dedicated functionality unit 322 can generate control signals (e.g., interruptions, alarms, or the like) and/or can cause the device 310 to transition between operational states in response to a defined condition of the device 310 or its environment. At least some of the control signals can be sent to an external device (not depicted in FIG. 3) via an I/O interface of the I/O interfaces 320. The type and/or number of components included in the dedicated functionality unit 322 can establish, at least in part, the complexity of the device 310. In some examples, the device 310 can embody or can constitute an AP device, and in other examples, the device 310 can embody or can constitute a SED or another type of IoT device.

The device 310 also can operate as a wireless communication device, communicating wirelessly in accordance with aspects of this disclosure. As such, the device 310 can embody or can constitute an AP device, a mobile computing device (e.g., a station device or user equipment), or other types of communication devices that can transmit and/or receive wireless communications in accordance with this disclosure. In some aspects, to permit wireless operation—including the exchange of information associated with configuration of a data path group, as described herein—the device 310 includes a radio unit 514 and a communication unit 326. In some implementations, the communication unit 326 can generate packets and/or other types of information blocks via a network stack, for example, and can convey the packets and/or the other types of information blocks to the radio unit 514 for wireless communication. In one embodiment, the network stack (not shown) can be embodied in or can constitute a library or other types of programming modules, and the communication unit 326 can execute the network stack in order to generate a packet or other types of information block. Generation of the packet or the other types of information blocks can include, for example, generation of control information (e.g., checksum data, communication address(es)), traffic information (e.g., payload data), and/or formatting of such information into a specific packet header.

As illustrated in FIG. 3, the radio unit 514 can include one or more antennas 316 and a multi-mode communication processing unit 518. In some embodiments, the antenna(s) 316 can be embodied in or can include directional or omnidirectional antennas, including, for example, dipole antennas, monopole antennas, patch antennas, loop antennas, microstrip antennas or other types of antennas suitable for transmission of RF signals. In addition, or in other embodiments, at least some of the antenna(s) 316 can be physically separated to leverage spatial diversity and related different channel characteristics associated with such diversity. Further or in yet other embodiments, the multi-mode communication processing unit 518 that can process at least wireless signals in accordance with one or more radio technology protocols and/or modes (such as multiple-input multiple-output (MIMO), single-input-multiple-output (SIMO), multiple-input-single-output (MISO), and the like). Each of such protocol(s) can be configured to communicate (e.g., transmit, receive, or exchange) data, metadata, and/or signaling over a specific air interface. The one or more radio technology protocols can include, for example, 3GPP UMTS; LTE; LTE-A; Wi-Fi protocols, such as those of the Institute of Electrical and Electronics Engineers (IEEE) 802.11 family of standards; Worldwide Interoperability for Microwave Access (WiMAX); radio technologies and related protocols for ad hoc networks, such as Bluetooth® or ZigBee®; other protocols for packetized wireless communication; or the like). The multi-mode communication processing unit 518 also can process non-wireless signals (analogic, digital, a combination thereof, or the like).

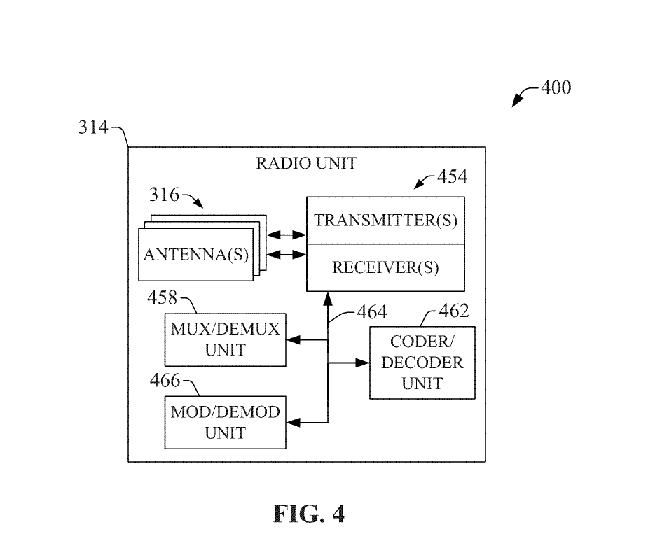

In some embodiments, e.g., example embodiment 400 shown in FIG. 4, the multi-mode communication processing unit 518 can comprise a set of one or more transmitters/receivers 454, and components therein (amplifiers, filters, analog-to-digital (A/D) converters, etc.), functionally coupled to a multiplexer/demultiplexer (mux/demux) unit 568, a modulator/demodulator (mod/demod) unit 466 (also referred to as modem 466), and a coder/decoder unit 512 (also referred to as codec 512). Each (or, in some instances, at least one) of the transmitter(s)/receiver(s) can form respective transceiver(s) that can transmit and receive wireless signal (e.g., electromagnetic radiation) via the one or more antennas 316. It is noted that in other embodiments, the multi-mode communication processing unit 318 can include, for example, other functional elements, such as one or more control units (e.g., a memory controller), an offload engine or unit, I/O interfaces, baseband processing circuitry, a combination of the foregoing, or the like. While illustrated as separate blocks in the device 310, it is noted that in some embodiments, at least a portion of the multi-mode communication processing unit 518, the communication unit 326, and/or data-path-group configuration unit can be integrated into a single unit—e.g., a single chipset or other type of solid state circuitry. In some aspects, such a single unit can be configured by programmed instructions retained in memory 530 and/or other memory devices integrated into or otherwise functionally coupled to the single unit.

Electronic components and associated circuitry, such as mux/demux unit 458, codec 462, and modem 466 can permit or otherwise facilitate processing and manipulation, e.g., coding/decoding, deciphering, and/or modulation/demodulation, of signal(s) received by the device 310 and signal(s) to be transmitted by the device 310. In some aspects, as described herein, received and transmitted wireless signals can be modulated and/or coded, or otherwise processed, in accordance with one or more radio technology protocols. Such radio technology protocol(s) can include, for example, 3GPP UMTS; 3GPP LTE; LTE-A; Wi-Fi protocols, such as IEEE 802.11 family of standards (IEEE 802.11ac, IEEE 802.11ax, and the like); IEEE 802.15.4; WiMAX; radio technologies and related protocols for ad hoc networks, such as Bluetooth® or ZigBee®; other protocols for packetized wireless communication; or the like.

The electronic components in the multi-mode communication processing unit 318, including the one or more transmitters/receivers 454, can exchange information (e.g., data, metadata, code instructions, signaling and related payload data, combinations thereof, or the like) through a bus 464, which can embody or can include at least one of a system bus, an address bus, a data bus, a message bus, a reference link or interface, a combination of the foregoing, or the like. Each (or, in some embodiments, at least one) of the one or more receivers/transmitters 454 can convert signal from analog to digital and vice versa. In addition or in the alternative, the receiver(s)/transmitter(s) 454 can divide a single data stream into multiple parallel data streams, or perform the reciprocal operation. Such operations may be conducted as part of various multiplexing schemes. As illustrated, the mux/demux unit 458 is functionally coupled to the one or more receivers/transmitters 454 and can permit processing of signals in time and frequency domain. In some aspects, the mux/demux unit 458 can multiplex and demultiplex information (e.g., data, metadata, and/or signaling) according to various multiplexing schemes such as time division multiplexing (TDM), frequency division multiplexing (FDM), orthogonal frequency division multiplexing (OFDM), spatial multiplexing OFDM (SM-OFDM), code division multiplexing (CDM), space division multiplexing (SDM). In addition or in the alternative, in another aspect, the mux/demux unit 458 can scramble and spread information (e.g., codes) according to most any code, such as Hadamard-Walsh codes, Baker codes, Kasami codes, polyphase codes, and the like. The modem 466 can modulate and demodulate information (e.g., data, metadata, signaling, or a combination thereof) according to various modulation techniques, such as frequency modulation (e.g., frequency-shift keying), amplitude modulation (e.g., M-ary quadrature amplitude modulation (QAM), with M a positive integer; amplitude-shift keying (ASK)), phase-shift keying (PSK), and the like). In addition, processor(s) that can be included in the device 310—e.g., processor(s) 324, or baseband processing circuitry or other type of computing circuitry included in the radio unit 514 or other functional element(s) of the device 310—can permit processing data (e.g., symbols, bits, or chips) for multiplexing/demultiplexing, modulation/demodulation (such as implementing direct and inverse fast Fourier transforms) selection of modulation rates, selection of data packet formats, inter-packet times, and the like.

The codec 462 can operate on information (e.g., data, metadata, signaling, or a combination thereof) in accordance with one or more coding/decoding schemes suitable for communication, at least in part, through the one or more transceivers formed from respective transmitter(s)/receiver(s) 454. In one aspect, such coding/decoding schemes, or related procedure(s), can be retained as computer-accessible instructions (computer-readable instructions, computer-executable instructions, or a combination thereof) in the memory 530 and/or other memory device integrated into or otherwise functionally coupled to the radio unit 514. In a scenario in which wireless communication among the device 310 and another computing device (e.g., a station device, other types of user equipment, or customer premises equipment) utilizes MIMO, MISO, SIMO, or SISO operation, the codec 462 can implement at least one of space-time block coding (STBC) and associated decoding, or space-frequency block (SFBC) coding and associated decoding. In addition or in other scenarios, the codec 462 can extract information from data streams coded in accordance with spatial multiplexing scheme. In some aspects, to decode received information (e.g., data, metadata, signaling, or a combination thereof), the codec 462 can implement at least one of computation of log-likelihood ratios (LLR) associated with constellation realization for a specific demodulation; maximal ratio combining (MRC) filtering, maximum-likelihood (ML) detection, successive interference cancellation (SIC) detection, zero forcing (ZF) and minimum mean square error estimation (MMSE) detection, or the like. The codec 462 can utilize, at least in part, mux/demux unit 458 and mod/demod unit 466 to operate in accordance with aspects described herein.

With further reference to FIG. 3, the device 310 can operate in a variety of wireless environments having wireless signals conveyed in different electromagnetic radiation (EM) frequency bands. To at least such end, the multi-mode communication processing unit 518 in accordance with aspects of the disclosure can process (code, decode, format, etc.) wireless signals within a set of one or more EM frequency bands (also referred to as frequency bands) comprising one or more of radio frequency (RF) portions of the EM spectrum, microwave portion(s) of the EM spectrum, or infrared (IR) portion(s) of the EM spectrum. In one aspect, the set of one or more frequency bands can include, for example, at least one of (i) all or most licensed EM frequency bands, (such as the industrial, scientific, and medical (ISM) bands, including the 2.4 GHz band or the 5 GHz bands); or (ii) all or most unlicensed frequency bands (such as the 60 GHz band) currently available for telecommunication.

As described herein, the device 310 can receive and/or transmit information encoded and/or modulated or otherwise processed in accordance with aspects of the present disclosure. To at least such an end, in some embodiments, the device 310 can acquire or otherwise access information wirelessly via the radio unit 514 (which also may be referred to as radio 514), where at least a portion of such information can be encoded and/or modulated in accordance with aspects described herein. Therefore, in some implementations, the memory 530 also can contain one or more memory elements having information suitable for processing information received according to a predetermined communication protocol (e.g., IEEE 802.11ac, IEEE 802.11ax, IEEE 802.15.4). While not shown, in some embodiments, one or more memory elements (e.g., registers, filed, databases, combinations thereof, or the like) of the memory 434 can include, for example, computer-accessible instructions that can be executed by one or more of the functional elements (units, components, circuitry, etc.) of the device 310 in order to implement at least some of the functionality for configuration of data path groups in a wireless network, in accordance with aspects described herein. One or more groups of such computer-accessible instructions can embody or can constitute a programming interface that can permit communication of information (e.g., data, metadata, and/or signaling) between functional elements of the device 310 for implementation of such functionality.

As further illustrated in FIG. 3, the device 310 can include one or more I/O interfaces 320. At least one of the I/O interface(s) 320 can permit the exchange of information between the device 310 and another computing device and/or a storage device. Such an exchange can be wireless (e.g., via near field communication or optically-switched communication) or wireline. At least another one of the I/O interface(s) 320 can permit presenting information visually, aurally, and/or via movement to an end-user of the device 310. In one example, a haptic device can embody the I/O interface of the I/O interface(s) 320 that permit conveying information via movement. In addition, in the illustrated device 310, a bus architecture 542 (which also may be referred to as bus 542) can permit the exchange of information (e.g., data, metadata, and/or signaling) between two or more functional elements of the device 310. For instance, the bus 542 can permit exchange of information between two or more of (i) the radio unit 514 or a functional element therein, (ii) at least one of the I/O interface(s) 320, (iii) the communication unit 326, or (iv) the memory 530 and elements therein. In addition, one or more application programming interfaces (APIs) (not depicted in FIG. 3) or other types of programming interfaces that can permit exchange of information (e.g., data and/or metadata) between two or more of the functional elements of the device 310. At least one of such API(s) can be retained or otherwise stored in the memory 530. In some embodiments, it is noted that at least one of the API(s) or other programming interfaces can permit the exchange of information within components of the communication unit 326. The bus 542 also can permit a similar exchange of information. In some embodiments, the bus 552 can embody or can include, for example, at least one of a system bus, an address bus, a data bus, a message bus, a reference link or interface, a combination thereof, or the like. In addition or in other embodiments, the bus 552 can include, for example, components for wireline and wireless communication.

It is noted that portions of the device 310 can embody or can constitute an apparatus. For instance, the multi-mode communication processing unit 518, the communication unit 326, and at least a portion of the memory 530 can embody or can constitute an apparatus that can operate in accordance with one or more aspects of this disclosure.

In some embodiments, the multi-mode communication processing unit 518 and/or the communication unit 326 can implement the detection processes in accordance with aspects of this disclosure. As mentioned, such detection processes can be some of the possible detection algorithms that can be applied to SM-OFDM waveforms. One example detection process includes a soft-output optimal joint maximum likelihood (ML) detection algorithm, which in some instances can be utilized a performance benchmark for other detections process of this disclosure. Another example detection process includes a soft-output list detection (LD) suboptimal detection algorithm.

Based at least in part on aspects of SM-OFDM, spectral efficiency can be divided into two information categories having two respective search spaces defined by a number of bits of each category. Specifically, the total spectral efficiency can be defined as N_{A} plus the N_{D}, where N_{A} is a number of antenna selection bits and N_{D} is a number of data bits. As mentioned, the number of antenna selection bits can be determined or otherwise selected using, at least in part, a space constellation including a set of possible transmit antennas combinations that can be used (exclusively or otherwise) during transmission from a transmitter device. In one aspect, the number of elements in the set can be equal to an index

$$n = {⌊ {log}_{2} ( ( \begin{matrix}{N}_{T} \\ {N}_{act}\end{matrix} ) ) ⌋}_{2} .$$

Similarly, the number of data bits can be determined or otherwise selected using, at least in part, a signal constellation diagram having a size determined by m=log₂ M, where M represents a signal constellation alphabet size. In some aspects, the overall search space for the soft-output optimal joint ML detection can be determined by the total spectral efficiency. Accordingly, in some embodiments, reducing a search space of the antenna selection bits category while improving performance can permit or otherwise facilitate addressing the overall detection algorithm complexity and performance tradeoff, especially for IoT devices and/or wearable devices. In some aspects, such a reduction of the search space can permit or otherwise facilitate the implementation of the soft-output LD suboptimal detection algorithm of the present disclosure.

In connection with soft-output optimal joint ML detection, in some aspects, the output a posteriori log-likelihood ratio (LLR) L(mⁱ) for the i-th antenna selection bit can be determined (e.g., estimated or otherwise computed) according to the following expression:

$$L ( {m}^{i} ) = log \frac{{\sum }_{\tilde{m} ∈ {m}_{1}^{i}} {\sum }_{\tilde{x} ∈ χ} exp ( - \frac{{‖ y - {h}_{\tilde{m}} \tilde{x} ‖}^{2}}{{σ}^{2}} )}{{\sum }_{\tilde{m} ∈ {m}_{0}^{i}} {\sum }_{\tilde{x} ∈ χ} exp ( - \frac{{‖ y - {h}_{\tilde{m}} \tilde{x} ‖}^{2}}{{σ}^{2}} )} . \qquad Eq . ( 1 )$$

Similarly, in some aspects, the LLRs L(x^{q}) for the q-th transmitted data bit at each subcarrier can be determined (e.g., estimated or otherwise computed) as follows:

$$L ( {x}^{q} ) = log \frac{{\sum }_{\tilde{x} ∈ {X}_{1}^{q}} {\sum }_{\tilde{m} ∈ m} exp ( - \frac{{‖ y - {h}_{\tilde{m}} \tilde{x} ‖}^{2}}{{σ}^{2}} )}{{\sum }_{\tilde{x} ∈ {X}_{0}^{q}} {\sum }_{\tilde{m} ∈ m} exp ( - \frac{{‖ y - {h}_{\tilde{m}} \tilde{x} ‖}^{2}}{{σ}^{2}} )} . \qquad Eq . ( 2 )$$

In Eq. (1) and Eq. (2), m and x represent, respectively, the set of all vectors of the antenna combination indices and the set of quadrature amplitude modulation (QAM) constellations (e.g., m=2^{Antenna Selection Bits} and x=2^{Data Bits}). In addition, y and σ² represent, respectively, the received signal and noise variance. In addition, m₁ⁱ and m₀ⁱ represent, respectively, the set of vectors of antenna combination indices which have “1” and “0” at the i-th bit location. Moreover, x₁^{q} and x₀^{q} represent, respectively, a set of vectors of data symbols having “1” and “0” at the q-th bit location. Finally, h\tilde{ₘ} represents the sub-channel matrix that corresponds to the active transmit antenna combination index \tilde{m}. Therefore, it can be gleaned from Eq. (1) and Eq. (2) that the detection complexity is mainly determined by the size of the set of all vectors of the antenna combination indices.

As mentioned, one of the example detection processes in accordance with the disclosure can be embodied in or can include a soft-output sub-optimal list detection (LD) process. In some aspects, in such a detection process, the previously described soft-output optimal joint ML detection can be implemented with a reduced search space for the antenna selection bits from \tilde{m} to m̅. The reduced search space can have a dimension (or, in some embodiments, a cardinality that represents a number of elements available for search in the search space) that is less than the corresponding dimension (or, in some embodiments, the corresponding cardinality) in the search space of the soft-output optimal joint ML detection process. In one example, m̅ can be defined or otherwise determined as a list of satisfactory (or, in some embodiments, the best) candidate antenna indices among a total list of indices in an initial search space utilized in the soft-output optimal joint ML detection. The list of satisfactory candidate antenna indices can be selected or otherwise determined on a selection rule that is applied to indices in the initial search space and, as a result, permits paring down (e.g., excluding) the number of indices in the initial search space. Numerous selection rules can be implemented. For instance, in some embodiments, the selection rule can be defined as a minimum Euclidean distance between a received signal and a modeled signal according to SM-OFDM. Specifically, in one embodiment, the reduced set of indices m̅ can be determined as follows:

$$L ( {m}^{i } ) = log \frac{{\sum }_{\tilde{m} ∈ {\overline{m}}_{1}^{i}} {\sum }_{\tilde{x} ∈ χ} exp ( - \frac{{‖ y - {h}_{\tilde{m}} \tilde{x} ‖}^{2}}{{σ}^{2}} )}{{\sum }_{\tilde{m} ∈ {\overline{m}}_{0}^{i}} {\sum }_{\tilde{x} ∈ χ} exp ( - \frac{{‖ y - {h}_{\tilde{m}} \tilde{x} ‖}^{2}}{{σ}^{2}} )} , \qquad Eq . ( 3 )$$

In some embodiments, such as the embodiment shown in FIG. 3, selectable reduced search spaces (e.g., selectable list of defined antenna indices) can be retained at the detection information storage 334. In response to (e.g., prior to or upon) receiving wireless signal, the communication unit 326 can select one of the selectable reduced search spaces in order to detect signal. Such a selection can be based on numerous factors, such as hardware operational conditions (e.g., number of antennas utilized for LD and number of other antennas utilized for other type of communication) or limitations (e.g., reliance of passive amplification); restrictions on power consumption imposed to the device 310; computing resources (e.g., processing power) available to the device 310; and/or a modulation and coding scheme (MCS) decoded by the communication unit 326 and the radio unit 314, individually or in cooperation. In addition or in other embodiments, the device 310 can determine (e.g., compute) a reduced search space (e.g., an instance of m̅) in response to receiving wireless signal modulated according to SM-OFDM.

Utilization or otherwise reliance on a reduced search space m̅ can yield modified LLRs L(mⁱ) for the i-th antenna selection bit, and modified LLRs L(x^{q}) for a q-th transmitted data bit at a subcarrier (e.g., at each tone) utilized in the SM-OFDM waveform of received wireless signal. Specifically, modified L(mⁱ) can be expressed as follows:

$$L ( {m}^{i} ) = log \frac{{\sum }_{\tilde{m} ∈ {\overline{m}}_{1}^{i}} {\sum }_{\tilde{x} ∈ χ} exp ( - \frac{{‖ y - {h}_{\tilde{m}} \tilde{x} ‖}^{2}}{{σ}^{2}} )}{{\sum }_{\tilde{m} ∈ {\overline{m}}_{0}^{i}} {\sum }_{\tilde{x} ∈ χ} exp ( - \frac{{‖ y - {h}_{\tilde{m}} \tilde{x} ‖}^{2}}{{σ}^{2}} )} , \qquad Eq . ( 3 )$$

and modified L(x^{q}) can be expressed as follows:

$$L ( {x}^{q} ) = log \frac{{\sum }_{\tilde{x} ∈ {X}_{1}^{q}} {\sum }_{\tilde{m} ∈ \overline{m}} exp ( - \frac{{‖ y - {h}_{\tilde{m}} \tilde{x} ‖}^{2}}{{σ}^{2}} )}{{\sum }_{\tilde{x} ∈ {X}_{0}^{q}} {\sum }_{\tilde{m} ∈ \overline{m}} exp ( - \frac{{‖ y - {h}_{\tilde{m}} \tilde{x} ‖}^{2}}{{σ}^{2}} )} . \qquad Eq . ( 4 )$$

In Eqs. (3) and (4), where m̅₁ⁱ and m̅₀ⁱ represent the set of vectors of antenna combination indices from the list of the best candidate antenna indices m which have “1” or “0” at the i-th bit location, respectively. Therefore, in one aspect, the union of such sets of vectors satisfies: m̅₁ⁱ∪m̅₀ⁱ=m̅.

In order to detect wireless signal having a SM-OFDM waveform, a receiver device via a component therein (e.g., communication unit 326 and/or multi-mode communication processing unit 518), for example, can determine (e.g., compute) the modified LLRs L(mⁱ) and/or L(x^{q}). In one example, the receiver device can be embodied in the device 310 shown in FIG. 3, and the component that performs the determination of modified LLRs can be embodied in or can include one or more of the multi-mode processing unit 318 or the communication unit 326. In another example, the receiver device can include baseband circuitry (e.g., processor(s), cache device(s), bus(es), etc.) that can permit or otherwise facilitate the computation of the modified LLRs.

In accordance with aspects of the disclosure, the satisfactory LD detection process described herein can determine and/or utilize a defined search space for antenna selection bits in in order to reduce the overall average detection complexity (e.g., the total search space) to be 2m̅χinstead of 2mχ. As described herein, m corresponds to a full set of antenna bits that forms a second search space having a dimension (or, in some embodiments, cardinality) that is greater than that of the defined search space (which can be referred to as a reduced search space). Accordingly, in an example scenario in which m̅=0.5 m, the detection complexity of the satisfactory (or, in some instances, suboptimal) LD detection process in accordance with this disclosure can be reduced by about 50% compared to a benchmark, optimal detection process. Such a reduction is significant and can dramatically improve performance of small and/or less complex devices, such as IoT devices and/or wearable devices.

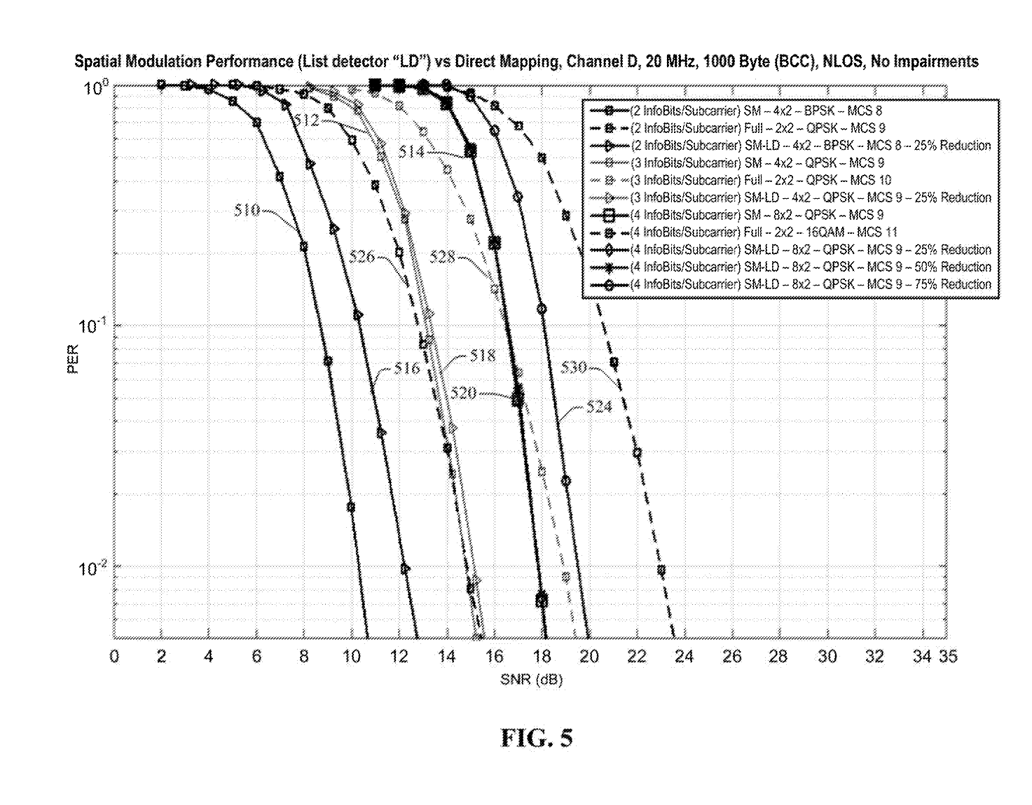

FIG. 5 illustrates results of an example simulation of an IEEE 802.11 wireless environment using different information rates and antenna configurations in accordance with one or more embodiments of the disclosure. Performance of a simulated wireless receiver is represented by packet error rate (PER) and is determined at different SNR. The wireless environments are modeled as non-line-of-sight (NLOS) environments having a communication channel of 20 MHz spectral bandwidth, where the channel is represented by a model channel D. Impairments, such as excessive foliage, Faraday cages, or the like) are excluded from the simulated environments. Different modulations techniques, e.g., BPSK, QPSK, and 16QAM, are utilized in the simulations. In some aspects consistent with an example SM-OFDM scenario, the simulation assumes that an AP device (e.g., AP device 114a) can have multiple antennas and a client device (e.g., station device 110a) can have only a few antennas (e.g., four antennas). Each of such antenna configurations can be represented as P×Q, where P (a natural number) indicates a number of antennas at the AP device (or any other transmitter device) and Q (a natural number) indicates the number of antennas at the client device. More specifically, the example simulated scenarios contemplate first AP devices having four antennas (P=4) and second AP devices having eight antennas (P=8), and client devices having two antennas (Q=2). Some of such scenarios are consistent with current network deployments under, and other scenarios can contemplate forthcoming implementations.

Simulation results for SM-OFDM soft-output optimal joint ML detection are labeled as “SM.” Specifically, such results are represented by trace 510, corresponding to simulation results for a 4×2 antenna configuration, BPSK modulation, and MCS 8; trace 512, corresponding to simulation results for a 4×2 antenna configuration, QPSK modulation, and MCS 9; and trace 514, corresponding to simulation results for a 8×2 antenna configuration, QPSK modulation, and MCS 9. Simulation results for SM-OFDM with a sub-optimal LD are labeled as “SM-LD,” and the results are obtained, in part, utilizing different amounts of reduction of the search space for antenna selection bits. A defined amount R is expressed as a percentage, and the results include a label “R Reduction.” Specifically, such results are represented by trace 516, corresponding to simulation results for a 4×2 antenna configuration, BPSK modulation, MCS 8, and R=25%; trace 518, corresponding to simulation results for a 4×2 antenna configuration, QPSK modulation, MCS 9, and R=25%; trace 520, corresponding to simulation results for a 8×2 antenna configuration, QPSK modulation, MCS 9, and R=25%; trace 522, corresponding to simulation results for a 8×2 antenna configuration, QPSK modulation, MCS 9, and R=50%; and trace 524, corresponding to simulation results for a 8×2 antenna configuration, QPSK modulation, MCS 9, and R=75%. As it can be gleaned from the results, simulations represented by traces 520 and 522 provide similar results despite the significant disparity in the reduction of the search space. In addition, for reference, simulation results obtained with a direct mapping optimal joint ML are also presented and labeled as “Full.” Specifically, such results are represented by trace 526, corresponding to simulation results for a 2×2 antenna configuration, QPSK modulation, and MCS 9; trace 528, corresponding to simulation results for a 2×2 antenna configuration, QPSK modulation, and MCS 10; and trace 530, corresponding to simulation results for a 2×2 antenna configuration, 16QAM modulation, and MCS 11. Without intending to be bound by theory and/or simulation, it can be gleaned from FIG. 5 that in the specific scenario where an AP device connects efficiently with IoT client devices (e.g., wearable client devices) that can be equipped with at most one or two antennas, SM-OFDM with a sub-optimal LD (SM-LD), as described herein, can have a gain of about 4 dB to about 5 dB over the direct mapping with the optimal joint ML. Such a gain is sizeable. It can further be gleaned from such results that reducing the search space of the antenna selection bits category up to 50% (e.g., reducing the overall receiver complexity up to 50%) does not impact significantly the overall performance of the wireless receiver of this disclosure. These results are much more pronounced in the case of the small and/or less complex devices like IoT client devices (e.g., wearable client devices).

Therefore, as illustrated in FIG. 5, the detection techniques and/or devices described herein can provide gains (in some instances, significant gains) over the direct mapping with the optimal joint ML detection procedure while reducing the receiver complexity up to 50% with almost no performance degradation.

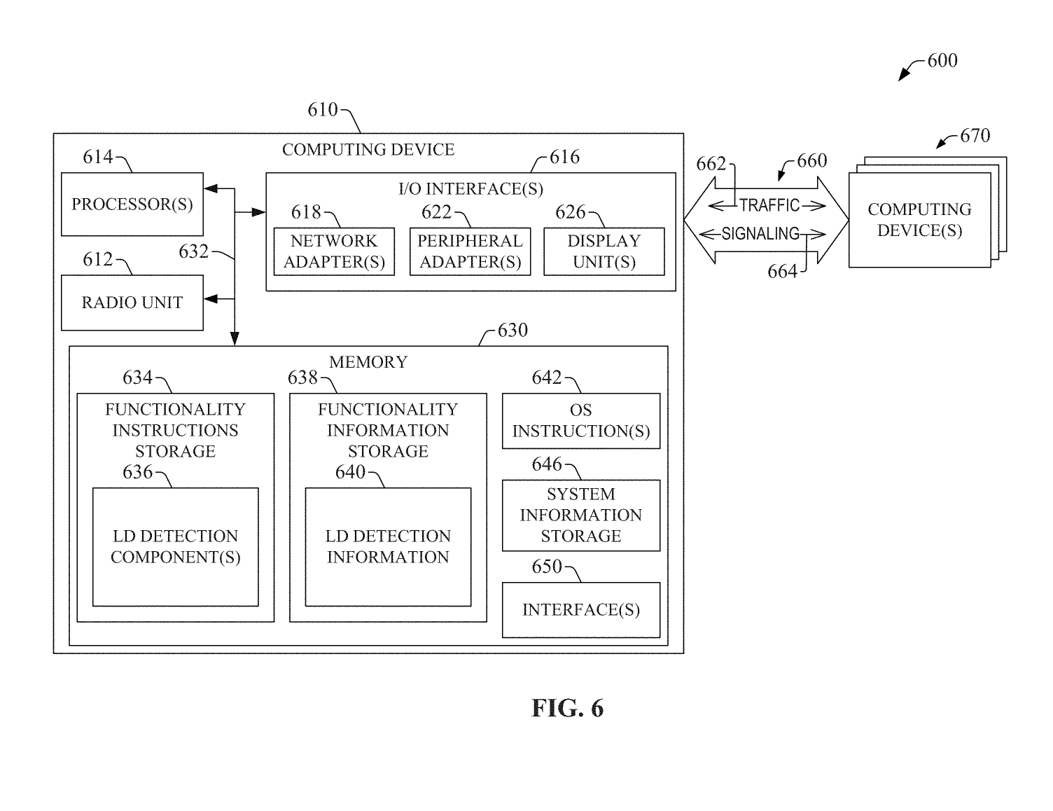

FIG. 6 illustrates an example of a computational environment 600 for wireless communication in accordance with one or more aspects of the disclosure. The example computational environment 600 is only illustrative and is not intended to suggest or otherwise convey any limitation as to the scope of use or functionality of such computational environments' architecture. In addition, the computational environment 600 should not be interpreted as having any dependency or requirement relating to any one or combination of components illustrated in this example computational environment. The illustrative computational environment 600 can embody or can include, for example, a device included in the example mesh network 200, one or more of the devices 116a or 116b, and/or any other computing device (e.g., device 410) that can implement or otherwise leverage the techniques for the detection of wireless signal using, at least in part, reduced search space(s) as described herein. In some embodiments, the computing device 610 can embody or can include any one of the devices in a low-power mesh network, such as the example mesh network 220 in FIG. 2. As such, the device 710 can embody a border router, a router, a leader device, or a SED. In other embodiments, the computing device can embody or can include the AP device 210 or any of the devices in the operational environment 100 in FIG. 1.

The computational environment 600 represents an example of a software implementation of the various aspects or features of the disclosure in which the processing or execution of operations described in connection with the techniques for the detection of wireless signal by a wireless signal receiver in accordance with aspects described herein can be performed in response to execution of one or more software components at the computing device 610. It should be appreciated that the one or more software components can render the computing device 610, or any other computing device that contains such components, a particular machine for detection of wireless signal, in accordance with aspects described herein, among other functional purposes. A software component can be embodied in or can comprise one or more computer-accessible instructions, e.g., computer-readable and/or computer-executable instructions. At least a portion of the computer-accessible instructions can embody one or more of the example techniques disclosed herein. For instance, to embody one such method, at least the portion of the computer-accessible instructions can be persisted (e.g., stored, made available, or stored and made available) in a computer storage non-transitory medium and executed by a processor. The one or more computer-accessible (or processor-accessible) instructions that embody a software component can be assembled into one or more program modules, for example, that can be compiled, linked, and/or executed at the computing device 610 or other computing devices. Generally, such program modules comprise computer code, routines, programs, objects, components, information structures (e.g., data structures and/or metadata structures), etc., that can perform particular tasks (e.g., one or more operations) in response to execution by one or more processors, which can be integrated into the computing device 610 or functionally coupled thereto.

The various example embodiments of the disclosure can be operational with numerous other general purpose or special purpose computing system environments or configurations. Examples of well-known computing systems, environments, and/or configurations that can be suitable for implementation of various aspects or features of the disclosure in connection with the detection of wireless signal can comprise personal computers; server computers; laptop devices; handheld computing devices, such as mobile tablets; wearable computing devices; and multiprocessor systems. Additional examples can include set top boxes, programmable consumer electronics, network PCs, minicomputers, mainframe computers, blade computers, programmable logic controllers, distributed computing environments that comprise any of the above systems or devices, and the like.

As illustrated, the computing device 610 can comprise one or more processors 614, one or more input/output (I/O) interfaces 616, a memory 630, and a bus architecture 632 (also termed bus 632) that functionally couples various functional elements of the computing device 610. As illustrated, the computing device 610 also can include a radio unit 612. In one example, similarly to the radio unit 414, the radio unit 612 can include one or more antennas and a communication processing unit that can permit wireless communication between the computing device 610 and another device, such as one of the computing device(s) 670. The bus 632 can include at least one of a system bus, a memory bus, an address bus, or a message bus, and can permit exchange of information (data, metadata, and/or signaling) between the processor(s) 614, the I/O interface(s) 616, and/or the memory 630, or respective functional element therein. In some scenarios, the bus 632 in conjunction with one or more internal programming interfaces 650 (also referred to as interface(s) 650) can permit such exchange of information. In scenarios in which processor(s) 614 include multiple processors, the computing device 610 can utilize parallel computing.

The I/O interface(s) 616 can permit or otherwise facilitate communication of information between the computing device and an external device, such as another computing device, e.g., a network element or an end-user device. Such communication can include direct communication or indirect communication, such as exchange of information between the computing device 610 and the external device via a network or elements thereof. As illustrated, the I/O interface(s) 616 can comprise one or more of network adapter(s) 618, peripheral adapter(s) 622, and display unit(s) 626. Such adapter(s) can permit or facilitate connectivity between the external device and one or more of the processor(s) 614 or the memory 630. In one aspect, at least one of the network adapter(s) 618 can couple functionally the computing device 610 to one or more computing devices 670 via one or more traffic and signaling pipes 660 that can permit or facilitate exchange of traffic 662 and signaling 664 between the computing device 610 and the one or more computing devices 670. Such network coupling provided at least in part by the at least one of the network adapter(s) 618 can be implemented in a wired environment, a wireless environment, or both. Therefore, it should be appreciated that in some embodiments, the functionality of the radio unit 612 can be provided by a combination of at least one of the network adapter(s) 618 and at least one of the processor(s) 614. Accordingly, in such embodiments, the radio unit 612 may not be included in the computing device 610. The information that is communicated by the at least one network adapter can result from implementation of one or more operations in a method of the disclosure. Such output can be any form of visual representation, including, but not limited to, textual, graphical, animation, audio, tactile, and the like. In some scenarios, each of the computing device(s) 670 can have substantially the same architecture as the computing device 610. In addition or in the alternative, the display unit(s) 626 can include functional elements (e.g., lights, such as light-emitting diodes; a display, such as liquid crystal display (LCD), combinations thereof, or the like) that can permit control of the operation of the computing device 610, or can permit conveying or revealing operational conditions of the computing device 610.

In one aspect, the bus 632 represents one or more of several possible types of bus structures, including a memory bus or memory controller, a peripheral bus, an accelerated graphics port, and a processor or local bus using any of a variety of bus architectures. As an illustration, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI) bus, a PCI-Express bus, a Personal Computer Memory Card Industry Association (PCMCIA) bus, Universal Serial Bus (USB), and the like. The bus 632, and all buses described herein can be implemented over a wired or wireless network connection and each of the subsystems, including the processor(s) 614, the memory 630 and memory elements therein, and the I/O interface(s) 616 can be contained within one or more remote computing devices 670 at physically separate locations, connected through buses of this form, in effect implementing a fully distributed system.

The computing device 610 can comprise a variety of computer-readable media. Computer readable media can be any available media (transitory and non-transitory) that can be accessed by a computing device. In one aspect, computer-readable media can comprise computer non-transitory storage media (or computer-readable non-transitory storage media) and communications media. Example computer-readable non-transitory storage media can be any available media that can be accessed by the computing device 610, and can comprise, for example, both volatile and non-volatile media, and removable and/or non-removable media. In one aspect, the memory 630 can comprise computer-readable media in the form of volatile memory, such as random access memory (RAM), and/or non-volatile memory, such as read only memory (ROM).

The memory 630 can comprise functionality instructions storage 634 and functionality information storage 638. The functionality instructions storage 634 can comprise computer-accessible instructions that, in response to execution (by at least one of the processor(s) 614), can implement one or more of the functionalities of the disclosure. The computer-accessible instructions can embody or can comprise one or more software components illustrated as LD detection component(s) 636. In one scenario, execution of at least one component of the LD detection component(s) 636 can implement one or more of the techniques disclosed herein. For instance, such execution can cause a processor that executes the at least one component to carry out a disclosed example method. It should be appreciated that, in one aspect, a processor of the processor(s) 614 that executes at least one of the LD detection component(s) 636 can retrieve information from or retain information in a memory element 640 in the functionality information storage 638 in order to operate in accordance with the functionality programmed or otherwise configured by the LD detection component(s) 636. Such information can include at least one of code instructions, information structures, or the like. At least one of the one or more interfaces 650 (e.g., application programming interface(s)) can permit or facilitate communication of information between two or more components within the functionality instructions storage 634. The information that is communicated by the at least one interface can result from implementation of one or more operations in a method of the disclosure, such as the example method 800 and/or the example method 900. In some embodiments, one or more of the functionality instructions storage 634 and the functionality information storage 638 can be embodied in or can comprise removable/non-removable, and/or volatile/non-volatile computer storage media.

At least a portion of at least one of the LD detection component(s) 636 or LD detection information 640 can program or otherwise configure one or more of the processors 614 to operate at least in accordance with the functionality described herein. One or more of the processor(s) 614 can execute at least one of such components and leverage at least a portion of the information in the storage 638 in order to provide mechanisms for detection of a wireless using, at least, a reduced search space, in accordance with one or more aspects described herein. As such, it should be appreciated that in some embodiments, a combination of the processor(s) 614, the LD detection component(s) 636, and the LD detection information 640 can form means for providing specific functionality for mechanism for detection of wireless signal using reduced search spaces for antenna bits and/or signal bits, in accordance with one or more aspects of the disclosure.

It should be appreciated that, in some scenarios, the functionality instruction(s) storage 634 can embody or can comprise a computer-readable non-transitory storage medium having computer-accessible instructions that, in response to execution, cause at least one processor (e.g., one or more of processor(s) 614) to perform a group of operations comprising the operations or blocks described in connection with the disclosed techniques for the detection of wireless signal by a device in a low-power mesh network or any other type of wireless devices, in accordance with this disclosure.

In addition, the memory 630 can comprise computer-accessible instructions and information (e.g., data and/or metadata) that permit or facilitate operation and/or administration (e.g., upgrades, software installation, any other configuration, or the like) of the computing device 610. Accordingly, as illustrated, the memory 630 can comprise a memory element 642 (labeled OS instruction(s) 642) that contains one or more program modules that embody or include one or more OSs, such as Windows operating system, Unix, Linux, Symbian, Android, Chromium, and substantially any OS suitable for mobile computing devices or tethered computing devices. In one aspect, the operational and/or architecture complexity of the computing device 610 can dictate a suitable OS. The memory 630 also comprises a system information storage 646 having data and/or metadata that permits or facilitate operation and/or administration of the computing device 610. Elements of the OS instruction(s) 642 and the system information storage 646 can be accessible or can be operated on by at least one of the processor(s) 614.

It should be recognized that while the functionality instructions storage 634 and other executable program components, such as the operating system instruction(s) 642, are illustrated herein as discrete blocks, such software components can reside at various times in different memory components of the computing device 610, and can be executed by at least one of the processor(s) 614. In some scenarios, an implementation of the LD detection component(s) 636 can be retained on or transmitted across some form of computer readable media.

The computing device 610 and/or one of the computing device(s) 670 can include a power supply (not shown), which can power up components or functional elements within such devices. The power supply can be a rechargeable power supply, e.g., a rechargeable battery, and it can include one or more transformers to achieve a power level suitable for operation of the computing device 610 and/or one of the computing device(s) 670, and components, functional elements, and related circuitry therein. In some scenarios, the power supply can be attached to a conventional power grid to recharge and ensure that such devices can be operational. In one aspect, the power supply can include an I/O interface (e.g., one of the network adapter(s) 618) to connect operationally to the conventional power grid. In another aspect, the power supply can include an energy conversion component, such as a solar panel, to provide additional or alternative power resources or autonomy for the computing device 610 and/or one of the computing device(s) 670.

The computing device 610 can operate in a networked environment by utilizing connections to one or more remote computing devices 670. As an illustration, a remote computing device can be a personal computer, a portable computer, a server, a router, a network computer, a peer device or other common network node, and so on. As described herein, connections (physical and/or logical) between the computing device 610 and a computing device of the one or more remote computing devices 670 can be made via one or more traffic and signaling pipes 660, which can comprise wireline link(s) and/or wireless link(s) and several network elements (such as routers or switches, concentrators, servers, and the like) that form a PAN, a LAN, a WAN, a WPAN, a WLAN, and/or a WWAN. Such networking environments are conventional and commonplace in dwellings, offices, enterprise-wide computer networks, intranets, local area networks, and wide area networks.

It should be appreciated that portions of the computing device 610 can embody or can constitute an apparatus. For instance, at least one of the processor(s) 614; at least a portion of the memory 630, including a portion of the LD detection component(s) 636 and a portion of the LD detection information 640; and at least a portion of the bus 632 can embody or can constitute an apparatus that can operate in accordance with one or more aspects of this disclosure.

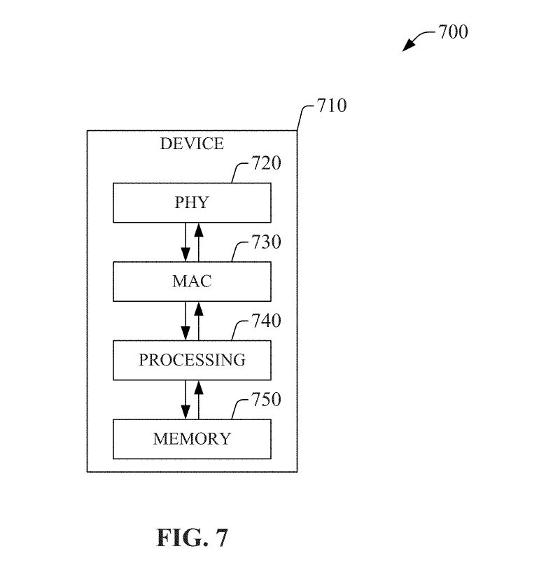

FIG. 7 presents another example embodiment 700 of a device 710 in accordance with one or more embodiments of the disclosure. The device 710 can embody or can include, for example, one of the communication devices 110a, 110b, or 110c; one or more of the base stations 114a, 114b, or 114c; and/or any other devices (e.g., device 410) that implements or otherwise leverages detection of wireless signals in accordance with aspects described herein. In some embodiments, the device 710 can embody or can include any one of the devices in a low-power mesh network, such as the example mesh network 220 in FIG. 2. As such, the device 710 can embody a border router, a router, a leader device, or a SED. In some embodiments, the device 710 can be a device compliant with IEEE 802.15.4 and/or Thread protocols that may be configured to communicate with one or more other similarly compliant devices and/or other types of communication devices, such as legacy communication devices. In addition or in other embodiments, the device 710 can be compliant with Wi-Fi protocols and/or Thread protocols. Devices compliant with IEEE 802.15.4 and/or Thread protocols may be broadly referred to as Thread devices and can operate in accordance with aspects described herein. As mentioned, Thread devices, such as border routers, also may operate in accordance with Wi-Fi protocols. In one implementation, the device 710 can operate as a commissioner device, a border router, a leader, a router, or a SED. As illustrated, the device 710 can include, among other things, physical layer (PHY) circuitry 1120 and media access control layer (MAC) circuitry 730. In one aspect, the PHY circuitry 710 and the MAC circuitry 730 can be layers compliant with IEEE 802.15.4 and/or Thread protocols, and also can be compliant, in some embodiments, with one or more Wi-Fi protocols, such as the family of IEEE 802.11 standards. In one aspect, the MAC circuitry 730 can be arranged to configure physical layer converge protocol (PLCP) protocol data units (PPDUs) and arranged to transmit and receive PPDUs, among other things. In addition or in other embodiments, the device 710 also can include other hardware processing circuitry 740 (e.g., one or more processors) and one or more memory devices 750 configured to perform the various operations described herein.

In some embodiments, the MAC circuitry 730 can be arranged to contend for a wireless medium during a contention period to receive control of the medium for a control period and configure a PPDU. In addition or in other embodiments, the PHY circuitry 720 can be arranged to transmit the PPDU. The PHY circuitry 720 can include circuitry for modulation/demodulation, upconversion/downconversion, filtering, amplification, etc. As such, the device 710 can include a transceiver to transmit and receive data such as PPDU. In some embodiments, the hardware processing circuitry 740 can include one or more processors. The hardware processing circuitry 740 can be configured to perform functions based on instructions being stored in a memory device (e.g., RAM or ROM) or based on special purpose circuitry. In some embodiments, the hardware processing circuitry 740 can be configured to perform one or more of the functions described herein, such as allocating bandwidth or receiving allocations of bandwidth.

In some embodiments, one or more antennas may be coupled to or included in the PHY circuitry 720. The antenna(s) can transmit and receive wireless signals, including transmission of HEW packets or other type of radio packets. As described herein, the one or more antennas can include one or more directional or omnidirectional antennas, including dipole antennas, monopole antennas, patch antennas, loop antennas, microstrip antennas or other types of antennas suitable for transmission of RF signals. In scenarios in which MIMO communication is utilized, the antennas may be physically separated to leverage spatial diversity and the different channel characteristics that may result.

The memory 750 can retain or otherwise store information for configuring the other circuitry to perform operations for configuring and transmitting packets compliant with Thread protocols and/or other types of radio packets, and performing the various operations described herein including, for example, detecting or otherwise receiving wireless signal in accordance with one or more embodiments of this disclosure.

The device 710 can be configured to communicate using OFDM communication signals over a multicarrier communication channel. More specifically, in some embodiments, the device 710 can be configured to communicate in accordance with one or more specific radio technology protocols, such as the IEEE family of standards including IEEE 802.11, IEEE 802.11n, IEEE 802.11ac, IEEE 802.11ax, IEEE 802.15.4, DensiFi, and/or proposed specifications for WLANs. In one of such embodiments, the device 710 can utilize or otherwise rely on symbols having a duration that is four times the symbol duration of IEEE 802.11n and/or IEEE 802.11ac. It should be appreciated that the disclosure is not limited in this respect and, in some embodiments, the device 710 also can transmit and/or receive wireless communications in accordance with other protocols and/or standards.

The device 710 can be embodied in or can constitute a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), an access point, a base station, a transmit/receive device for a wireless standard such as IEEE 802.11, IEEE 802.15.4, or IEEE 802.16, or other types of communication device that may receive and/or transmit information wirelessly. Similarly to the computing device 610, the device 710 can include, for example, one or more of a keyboard, a display, a non-volatile memory port, multiple antennas, a graphics processor, an application processor, speakers, and other mobile device elements. The display may be an LCD screen including a touch screen.

It should be appreciated that while the device 710 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating or otherwise executing on one or more processors. It should further be appreciated that portions of the device 710 can embody or can constitute an apparatus. For instance, the processing circuitry 740 and the memory 750 can embody or can constitute an apparatus that can operate in accordance with one or more aspects of this disclosure. The apparatus also can include functional elements (e.g., a bus architecture and/or API(s) as described herein) that can permit exchange of information between the processing circuitry 740 and the memory 750.

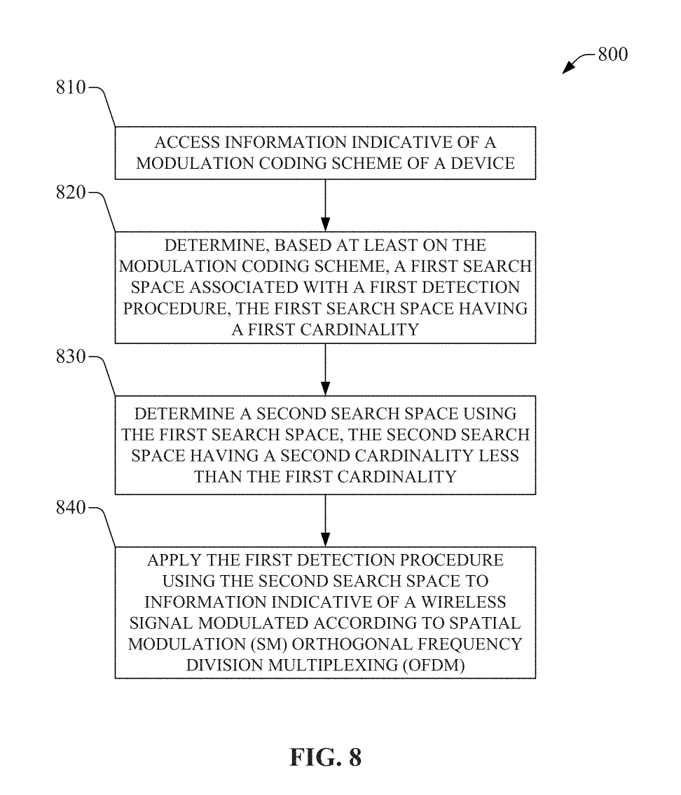

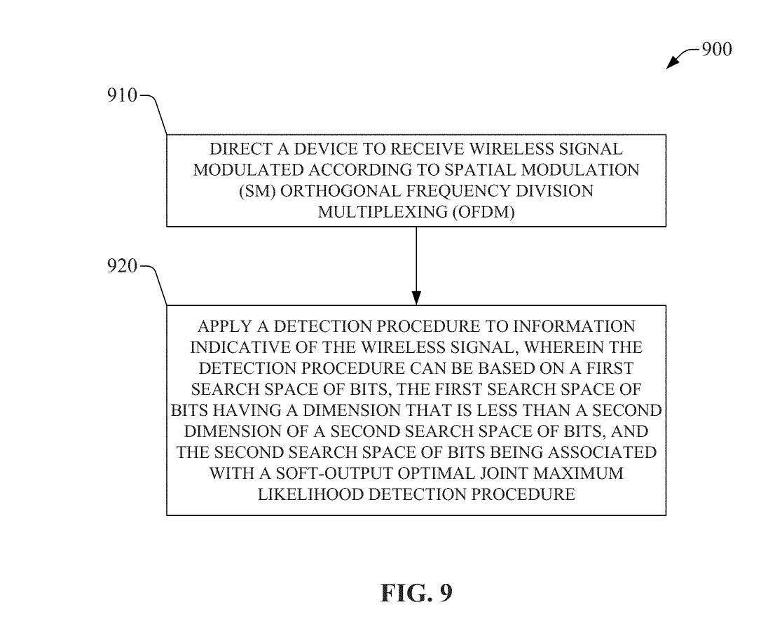

Example techniques that can be implemented in accordance with aspects of this disclosure may be further appreciated with reference to the flowcharts in FIGS. 8-9. While the examples techniques are presented as flowcharts, it is noted that other representations are possible, such as state machines and the like. In addition, while two flowcharts represent the example techniques, it is noted that other techniques that result from the combination of some or all of the two example flowcharts also can be implemented in accordance with this disclosure. More specifically, as illustrated, FIG. 8 illustrates an example method 800 for implementing a wireless signal receiver in accordance with at least aspects of this disclosure. In some embodiments, at least one processor can implement one or more of the blocks of the example method 800. The at least one processor can be coupled to at least one memory device that can include computer-readable and/or computer-executable instructions that, in response to execution, can permit or otherwise facilitate the at least one processor to implement at least a portion of the subject example method. In addition or in other embodiments, a device, or circuitry or other type of component(s) of the device, can implement at least a portion of the example method 800. At block 810, a device can access information indication or otherwise representative of a modulation coding scheme of the device can be accessed. At block 820, based at least on the modulation coding scheme, a first search space associated with a first detection procedure can be determined by the device. In some aspects, the first search space can have a first cardinality. At block 830, the device can determine a second search space using the first search space. In some aspects, the second search space can have a second cardinality less than the first cardinality. Accordingly, as described herein, the second search space can have a number of elements (represented by the second cardinality) that is less than another number of elements (represented by the first cardinality) of the first search space. At block 840, the device can apply the first detection procedure using the second search space to information indicative of a wireless signal modulated according to spatial modulation (SM) orthogonal frequency division multiplexing (OFDM).

FIG. 9 illustrates an example method 900 for implementing a wireless signal receiver in accordance with at least aspects of this disclosure. In some embodiments, at least one processor can implement one or more of the blocks of the example method 900. The at least one processor can be coupled to at least one memory device that can include computer-readable and/or computer-executable instructions that, in response to execution, can permit or otherwise facilitate the at least one processor to implement at least a portion of the subject example method. In addition or in other embodiments, a device, or circuitry or other type of component(s) of the device, can implement at least a portion of the example method 900. At block 910, a component (e.g., circuitry) of a device can direct the device to receive wireless signal modulated according to spatial modulation (SM) orthogonal frequency division multiplexing (OFDM). At block 920, the device can apply a detection procedure to information indicative of the wireless signal, wherein the detection procedure can be based on a first search space of bits, the first search space of bit having a dimension that is less than a second dimension of a second search space of bits. In some aspects, the second search space of bits can be associated with a soft-output optimal joint maximum likelihood detection procedure as described herein.

Various examples embodiments emerge from the foregoing description and the appended the claims. More specifically, in one example embodiment, the disclosure provides a device. The device includes at least one memory device having instructions programmed thereon; and at least one processor configured to access the at least one memory device and further configured to execute the instructions to: access information indicative of a modulation coding scheme of the device; determine, based at least on the modulation coding scheme, a first search space associated with a first detection procedure, the first search space having a first cardinality; determine a second search space using the first search space, the second search space having a second cardinality less than the first cardinality; and apply the first detection procedure using the second search space to information indicative of a wireless signal modulated according to spatial modulation (SM) orthogonal frequency division multiplexing (OFDM).

In addition or in other embodiments of the device, the first detection procedure comprises a list detection procedure. Further or in other embodiments of the device, the first detection procedure comprises a soft-output optimal joint maximum likelihood detection procedure.

Further or other embodiments of the device, to apply the first detection procedure using the second search space, the at least one processor is further configured to execute the instructions to determine an a posteriori log-likelihood ratio for an antenna selection bit associated with the wireless signal. Furthermore or in yet other embodiments of the device, to apply the first detection procedure using the second search space, the at least one processor is further configured to execute the instructions to determine an a posteriori log-likelihood ratio for a transmitted data bit at a subcarrier associated with the wireless signal. In some examples, the first search space comprises first list of antenna indices associated with the wireless signal.

Further or in yet other embodiments of the device, to determine the second search space using the first search space, the processor is further configured to execute the instructions to select an antenna index from the first list of antenna indices using at least a selection rule. In some examples, the selection rule comprises a minimum Euclidean distance between the wireless signal and a modeled signal according to SM-OFDM.

The disclosure also can provide, in some example embodiments, another device. Such a device can include at least one memory device having instructions programmed thereon; and at least one processor configured to access the at least one memory device and further configured to execute the instructions to: direct the device to receive wireless signal modulated according to spatial modulation (SM) orthogonal frequency division multiplexing (OFDM); apply a detection procedure to information indicative of the wireless signal, wherein the detection procedure is based on a first search space of bits, the first search space of bits having a dimension that is less than a second dimension of a second search space of bits, and the second search space of bits being associated with a soft-output optimal joint maximum likelihood detection procedure. In some examples, the first search space comprises a list of antenna indices associated with the wireless signal.

Further or in other embodiments of the device, the at least one processor is further configured to execute the instructions to determine the second search space using the first search space. Furthermore or in yet other embodiments of the device, to determine the second search space using the first search space, the at least one processor is further configured to execute the instructions to select at least one antenna index from the list of antenna indices using at least a selection rule. In some examples, the selection rule comprises a minimum Euclidean distance between the wireless signal and a modeled signal according to SM-OFDM.

The disclosure also can provide, in some example embodiments, at least one computer-readable storage device having instructions encoded thereon that, in response to execution, direct a device to perform or facilitate operations comprising: accessing information indicative of a modulation coding scheme of the device; determining, based at least on the modulation coding scheme, a first search space associated with a first detection procedure, the first search space having a first cardinality; determining a second search space using the first search space, the second search space having a second cardinality less than the first cardinality; and applying the first detection procedure using the second search space to information indicative of a wireless signal modulated according to spatial modulation (SM) orthogonal frequency division multiplexing (OFDM). In some examples, the first detection procedure comprises a list detection procedure. In addition or in other examples, the first detection procedure comprises a soft-output optimal joint maximum likelihood detection procedure.

In some examples of the at least one computer-readable storage device, the applying the first detection procedure using the second search space comprises determining an a posteriori log-likelihood ratio for an antenna selection bit associated with the wireless signal. In addition or in other examples of the at least one computer-readable storage device, the applying the first detection procedure using the second search space comprises determining an a posteriori log-likelihood ratio for a transmitted data bit at a subcarrier associated with the wireless signal.

In some aspects, the first search space comprises first list of antenna indices associated with the wireless signal. In addition or in other aspects, the first search space comprises first list of antenna indices associated with the wireless signal, and wherein determining the second search space using the first search space comprises selecting an antenna index from the first list of antenna indices using at least a selection rule. Further or in yet other aspects, the selection rule can include a minimum Euclidean distance between the wireless signal and a modeled signal according to SM-OFDM.

The disclosure also can provide, in some examples embodiments, a method including accessing information indicative of a modulation coding scheme of the device; determining, based at least on the modulation coding scheme, a first search space associated with a first detection procedure, the first search space having a first cardinality; determining a second search space using the first search space, the second search space having a second cardinality less than the first cardinality; and applying the first detection procedure using the second search space to information indicative of a wireless signal modulated according to spatial modulation (SM) orthogonal frequency division multiplexing (OFDM).

In some example embodiments of the method, the first detection procedure can include a list detection procedure. In addition or in some other embodiments of the method, the first detection procedure can include a soft-output joint optimal maximum likelihood detection procedure.

In some aspects of the method the applying the first detection procedure using the second search space can include comprises determining an a posteriori log-likelihood ratio for an antenna selection bit associated with the wireless signal. In addition or in other aspects of the method, the applying the first detection procedure using the second search space can include determining an a posteriori log-likelihood ratio for a transmitted data bit at a subcarrier associated with the wireless signal. In some aspects of the method, the first search space comprises first list of antenna indices associated with the wireless signal. Further or in other aspects of the method, the first search space comprises first list of antenna indices associated with the wireless signal, and wherein determining the second search space using the first search space comprises selecting an antenna index from the first list of antenna indices using at least a selection rule. Further or in yet other aspects of the method, the selection rule can include a minimum Euclidean distance between the wireless signal and a modeled signal according to SM-OFDM.

The disclosure also can provide, in some example, an apparatus comprising means for accessing information indicative of a modulation coding scheme of the device; means for determining, based at least on the modulation coding scheme, a first search space associated with a first detection procedure, the first search space having a first cardinality; means for determining a second search space using the first search space, the second search space having a second cardinality less than the first cardinality; and means for applying the first detection procedure using the second search space to information indicative of a wireless signal modulated according to spatial modulation (SM) orthogonal frequency division multiplexing (OFDM). In some examples of the apparatus, the first detection procedure comprises a list detection procedure. In other examples of the apparatus, wherein the first detection procedure comprises a soft-output joint optimal maximum likelihood detection procedure.

Further, in some examples of the apparatus, the means for applying the first detection procedure using the second search space comprises determining an a posteriori log-likelihood ratio for an antenna selection bit associated with the wireless signal. In addition or in other examples of the apparatus, the means for applying the first detection procedure using the second search space comprises determining an a posteriori log-likelihood ratio for a transmitted data bit at a subcarrier associated with the wireless signal.

In some aspects of the apparatus, the first search space can include first list of antenna indices associated with the wireless signal. In addition or in other aspects of the apparatus, the first search space comprises first list of antenna indices associated with the wireless signal, and wherein means for determining the second search space using the first search space comprises selecting an antenna index from the first list of antenna indices using at least a selection rule. Further or in other aspects of the apparatus, the selection rule can include a minimum Euclidean distance between the wireless signal and a modeled signal according to SM-OFDM.

The disclosure also can provide, in some example embodiments, a non-transitory computer-readable medium storing computer-executable instructions that, when executed by one or more processors, perform or facilitate operations including directing the device to receive wireless signal modulated according to spatial modulation (SM) orthogonal frequency division multiplexing (OFDM); and applying a detection procedure to information indicative of the wireless signal, wherein the detection procedure is based on a first search space of bits, the first search space of bits having a dimension that is less than a second dimension of a second search space of bits, and the second search space of bits being associated with a soft-output optimal joint maximum likelihood detection procedure.

In some examples of the non-transitory computer-readable medium, the first search space comprises a list of antenna indices associated with the wireless signal. In addition or in other examples of the non-transitory computer-readable medium, the operations can further include determining the second search space using the first search space.

In some aspects of the non-transitory computer-readable medium, the determining the second search space using the first search space, the operations can further include selecting at least one antenna index from the list of antenna indices using at least a selection rule. In addition or in other aspects of the non-transitory computer-readable medium, the selection rule can include a minimum Euclidean distance between the wireless signal and a modeled signal according to SM-OFDM.

The disclosure also can provide, in some example embodiments, a method including directing a device to receive wireless signal modulated according to spatial modulation (SM) orthogonal frequency division multiplexing (OFDM); and applying a detection procedure to information indicative of the wireless signal, wherein the detection procedure is based on a first search space of bits, the first search space of bits having a dimension that is less than a second dimension of a second search space of bits, and the second search space of bits being associated with a soft-output optimal joint maximum likelihood detection procedure. In some aspects of the method, the first search space can include a list of antenna indices associated with the wireless signal.

In addition or in some examples embodiments of the method, the operations can further include determining the second search space using the first search space. In some aspects of the method, determining the second search space using the first search space can further include selecting at least one antenna index from the list of antenna indices using at least a selection rule. In some aspects of the method, the selection rule can include a minimum Euclidean distance between the wireless signal and a modeled signal according to SM-OFDM.

The disclosure also can provide, in some example embodiments, an apparatus including means for directing the device to receive wireless signal modulated according to spatial modulation (SM) orthogonal frequency division multiplexing (OFDM); and means for applying a detection procedure to information indicative of the wireless signal, wherein the detection procedure is based on a first search space of bits, the first search space of bits having a dimension that is less than a second dimension of a second search space of bits, and the second search space of bits being associated with a soft-output optimal joint maximum likelihood detection procedure. In some aspects of the apparatus, the first search space comprises a list of antenna indices associated with the wireless signal.

In addition or in some embodiments, the operations can further include means for determining the second search space using the first search space. Further or in other embodiments of the apparatus, the means for determining the second search space using the first search space can further include means for selecting at least one antenna index from the list of antenna indices using at least a selection rule. In some aspects of the apparatus, the selection rule can include a minimum Euclidean distance between the wireless signal and a modeled signal according to SM-OFDM.

Various embodiments of the disclosure may take the form of an entirely or partially hardware embodiment, an entirely or partially software embodiment, or a combination of software and hardware (e.g., a firmware embodiment). Furthermore, as described herein, various embodiments of the disclosure (e.g., methods and systems) may take the form of a computer program product comprising a computer-readable non-transitory storage medium having computer-accessible instructions (e.g., computer-readable and/or computer-executable instructions) such as computer software, encoded or otherwise embodied in such storage medium. Those instructions can be read or otherwise accessed and executed by one or more processors to perform or permit performance of the operations described herein. The instructions can be provided in any suitable form, such as source code, compiled code, interpreted code, executable code, static code, dynamic code, assembler code, combinations of the foregoing, and the like. Any suitable computer-readable non-transitory storage medium may be utilized to form the computer program product. For instance, the computer-readable medium may include any tangible non-transitory medium for storing information in a form readable or otherwise accessible by one or more computers or processor(s) functionally coupled thereto. Non-transitory storage media can include read only memory (ROM); random access memory (RAM); magnetic disk storage media; optical storage media; flash memory, etc.

Embodiments of the operational environments and techniques (procedures, methods, processes, and the like) are described herein with reference to block diagrams and flowchart illustrations of methods, systems, apparatuses and computer program products. It can be understood that each block of the block diagrams and flowchart illustrations, and combinations of blocks in the block diagrams and flowchart illustrations, respectively, can be implemented by computer-accessible instructions. In certain implementations, the computer-accessible instructions may be loaded or otherwise incorporated into a general purpose computer, special purpose computer, or other programmable information processing apparatus to produce a particular machine, such that the operations or functions specified in the flowchart block or blocks can be implemented in response to execution at the computer or processing apparatus.

Blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Unless otherwise expressly stated, it is in no way intended that any protocol, procedure, process, or method set forth herein be construed as requiring that its acts or steps be performed in a specific order. Accordingly, where a process or method claim does not actually recite an order to be followed by its acts or steps or it is not otherwise specifically recited in the claims or descriptions of the subject disclosure that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification or annexed drawings, or the like.

As used in this application, the terms “component,” “node,” “environment,” “system,” “architecture,” “interface,” “unit,” “engine,” “platform,” “module,” and the like are intended to refer to a computer-related entity or an entity related to an operational apparatus with one or more specific functionalities. Such entities may be either hardware, a combination of hardware and software, software, or software in execution. As an example, a component may be, but is not limited to being, a process running on a processor, a processor, an object, an executable portion of software, a thread of execution, a program, and/or a computing device. For example, both a software application executing on a computing device and the computing device can be a component. One or more components may reside within a process and/or thread of execution. A component may be localized on one computing device or distributed between two or more computing devices. As described herein, a component can execute from various computer-readable non-transitory media having various data structures stored thereon. Components can communicate via local and/or remote processes in accordance, for example, with a signal (either analogic or digital) having one or more data packets (e.g., data from one component interacting with another component in a local system, distributed system, and/or across a network such as a wide area network with other systems via the signal). As another example, a component can be an apparatus with specific functionality provided by mechanical parts operated by electric or electronic circuitry that is controlled by a software application or firmware application executed by a processor, wherein the processor can be internal or external to the apparatus and can execute at least a part of the software or firmware application. As yet another example, a component can be an apparatus that provides specific functionality through electronic components without mechanical parts, the electronic components can include a processor therein to execute software or firmware that confers at least in part the functionality of the electronic components. An interface can include input/output (I/O) components as well as associated processor, application, and/or other programming components. The terms “component,” “environment,” “system,” “architecture,” “interface,” “unit,” “engine,” “platform,” “module” can be utilized interchangeably and can be referred to collectively as functional elements.

In the present specification and annexed drawings, reference to a “processor” is made. As utilized herein, a processor can refer to any computing processing unit or device comprising single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit (IC), an application-specific integrated circuit (ASIC), a digital signal processor (DSP), a field programmable gate array (FPGA), a programmable logic controller (PLC), a complex programmable logic device (CPLD), a reduced instruction set computing (RISC) microprocessor, a discrete gate or transistor logic, discrete hardware components, or any combination thereof designed to perform the functions described herein. A processor can be implemented as a combination of computing processing units. In certain embodiments, processors can utilize nanoscale architectures, such as molecular and quantum-dot based transistors, switches and gates, in order to optimize space usage or enhance performance of user equipment.

In addition, in the present specification and annexed drawings, terms such as “store,” storage,” “data store,” “data storage,” “memory,” “repository,” and substantially any other information storage component relevant to operation and functionality of a component of the disclosure, refer to “memory components,” entities embodied in a “memory,” or components forming the memory. It can be appreciated that the memory components or memories described herein embody or comprise non-transitory computer storage media that can be readable or otherwise accessible by a computing device. Such media can be implemented in any methods or technology for storage of information such as computer-readable instructions, information structures, program modules, or other information objects. The memory components or memories can be either volatile memory or non-volatile memory, or can include both volatile and non-volatile memory. In addition, the memory components or memories can be removable or non-removable, and/or internal or external to a computing device or component. Example of various types of non-transitory storage media can comprise hard-disc drives, zip drives, CD-ROM, digital versatile disks (DVD) or other optical storage, magnetic cassettes, magnetic tape, magnetic disk storage or other magnetic storage devices, flash memory cards or other types of memory cards, cartridges, or any other non-transitory medium suitable to retain the desired information and which can be accessed by a computing device.

As an illustration, non-volatile memory can include read only memory (ROM), programmable ROM (PROM), electrically programmable ROM (EPROM), electrically erasable ROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). The disclosed memory components or memories of operational environments described herein are intended to comprise one or more of these and/or any other suitable types of memory.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

What has been described herein in the present specification and annexed drawings includes examples of systems, devices, techniques, and computer program products that can provide a reduced complexity wireless signal receiver, for the detection of wireless signals, that can be deployed in network environment that can leverage spatial multiplexing orthogonal division frequency multiplexing. It is, of course, not possible to describe every conceivable combination of elements and/or methods for purposes of describing the various elements of the disclosure, but it can be recognized that many further combinations and permutations of the disclosed features are possible. Accordingly, it may be apparent that various modifications can be made to the disclosure without departing from the scope or spirit thereof. In addition or in the alternative, other embodiments of the disclosure may be apparent from consideration of the specification and annexed drawings, and practice of the disclosure as presented herein. It is intended that the examples put forward in the specification and annexed drawings be considered, in all respects, as illustrative and not restrictive. Although specific terms are employed herein, they are used in a generic and descriptive sense only and not for purposes of limitation.

1. A device, comprising:
at least one memory device having instructions programmed thereon; and
at least one processor configured to access the at least one memory device and further configured to execute the instructions to:
access information indicative of an index indicating a modulation coding scheme of the device;
determine, based at least on the modulation coding scheme, a first search space associated with a first detection procedure, the first search space having a first cardinality, and wherein the first search space comprises a first list of antenna indices, and the first list of antenna indices is based on a one or more active transmit antenna indices selected from a set of transmit antenna indices;
determine a second search space using the first search space, the second search space having a second cardinality less than the first cardinality; and
apply the first detection procedure using the second search space to information indicative of a wireless signal modulated according to spatial modulation (SM) orthogonal frequency division multiplexing (OFDM).

2. The device of claim 1, wherein the first detection procedure comprises a list detection procedure.

3. The device of claim 1, wherein the first detection procedure comprises a soft-output optimal joint maximum likelihood detection procedure.

4. The device of claim 1, wherein to apply the first detection procedure using the second search space, the at least one processor is further configured to execute the instructions to determine an a posteriori log-likelihood ratio for an antenna selection bit associated with the wireless signal.

5. The device of claim 1, wherein to apply the first detection procedure using the second search space, the at least one processor is further configured to execute the instructions to determine an a posteriori log-likelihood ratio for a transmitted data bit at a subcarrier associated with the wireless signal.

6. (canceled)

7. The device of claim 6, wherein to determine the second search space using the first search space, the processor is further configured to execute the instructions to select an antenna index from the first list of antenna indices using at least a selection rule.

8. The device of claim 7, wherein the selection rule comprises a minimum Euclidean distance between the wireless signal and a modeled signal according to SM-OFDM.

9. A device, comprising:
at least one memory device having instructions programmed thereon; and
at least one processor configured to access the at least one memory device and further configured to execute the instructions to:
direct the device to receive wireless signal modulated according to spatial modulation (SM) orthogonal frequency division multiplexing (OFDM);
apply a detection procedure to information indicative of the wireless signal, wherein:
the detection procedure uses a first search space of bits based on a modulation coding scheme, the first search space of bits having a dimension that is less than a second dimension of a second search space of bits, the second search space of bits being associated with a soft-output optimal joint maximum likelihood detection procedure, and
the first search space comprises a first list of antenna indices, and the first list of antenna indices is based on a one or more active transmit antenna indices selected from a set of transmit antenna indices.

10. (canceled)

11. The device of claim 9, wherein the at least one processor is further configured to execute the instructions to determine the second search space using the first search space.

12. The device of claim 11, wherein to determine the second search space using the first search space, the at least one processor is further configured to execute the instructions to select at least one antenna index from the list of antenna indices using at least a selection rule.

13. The device of claim 12, wherein the selection rule comprises a minimum Euclidean distance between the wireless signal and a modeled signal according to SM-OFDM.

14. At least one computer-readable storage device having instructions encoded thereon that, in response to execution, direct a device to perform or facilitate operations comprising:
accessing information indicative of an index indicating a modulation coding scheme of the device;
determining, based at least on the modulation coding scheme, a first search space associated with a first detection procedure, the first search space having a first cardinality, and wherein the first search space comprises a first list of antenna indices, and the first list of antenna indices is based on a one or more active transmit antenna indices selected from a set of transmit antenna indices;
determining a second search space using the first search space, the second search space having a second cardinality less than the first cardinality; and
applying the first detection procedure using the second search space to information indicative of a wireless signal modulated according to spatial modulation (SM) orthogonal frequency division multiplexing (OFDM).

15. The at least one computer-readable storage device of claim 14, wherein the first detection procedure comprises a list detection procedure.

16. The at least one computer-readable storage device of claim 14, wherein the first detection procedure comprises a soft-output optimal joint maximum likelihood detection procedure.

17. The at least one computer-readable storage device of claim 14, wherein the applying the first detection procedure using the second search space comprises determining an a posteriori log-likelihood ratio for an antenna selection bit associated with the wireless signal.

18. The at least one computer-readable storage device of claim 14, wherein the applying the first detection procedure using the second search space comprises determining an a posteriori log-likelihood ratio for a transmitted data bit at a subcarrier associated with the wireless signal.

19. The at least one computer-readable storage device of claim 18, wherein determining the second search space using the first search space comprises selecting an antenna index from the first list of antenna indices using at least a selection rule.

20. The at least one computer-readable storage device of claim 19, wherein the selection rule comprises a minimum Euclidean distance between the wireless signal and a modeled signal according to SM-OFDM.

21. The device of claim 1, wherein the cardinality of the first search space is based on a number of indices in the first list of antenna indices.

22. The device of claim 9, wherein the cardinality of the first search space is based on a number of indices in the first list of antenna indices.
